(19) United States
(12) Patent Application Publication
(10) Pub. No.: US 2025/0339337 A1
(43) Pub. Date: Nov. 6, 2025

(54) MEDICATION SUPPORT APPARATUS

(71) Applicants: Hiroshi Fujie, Kanagawa (JP); Terumitsu Azuma, Kanagawa (JP); Yoshihide Sugiyama, Kanagawa (JP); Hirotaka Hayashi, Kanagawa (JP); Manabu Yamanaka, Kanagawa (JP); Takato Mochizuki, Kanagawa (JP); Youhei Niitsuma, Kanagawa (JP); Sachika Tashiro, Kanagawa (JP)

(72) Inventors: Hiroshi Fujie, Kanagawa (JP); Terumitsu Azuma, Kanagawa (JP); Yoshihide Sugiyama, Kanagawa (JP); Hirotaka Hayashi, Kanagawa (JP); Manabu Yamanaka, Kanagawa (JP); Takato Mochizuki, Kanagawa (JP); Youhei Niitsuma, Kanagawa (JP); Sachika Tashiro, Kanagawa (JP)

(73) Assignee: Ricoh Company, Ltd., Tokyo (JP)

(21) Appl. No.: 19/183,882

(22) Filed: Apr. 20, 2025

(30) Foreign Application Priority Data
May 2, 2024 (JP) 2024-074978

(51) Int. Cl. A61J 1/03; G06K 7/10; G06K 7/14

(52) U.S. Cl. CPC A61J 1/03; G06K 7/10445; G06K 7/1417; A61J 2205/10

(57) ABSTRACT

A medication support apparatus includes a container to store a medicine pack, a conveyor to pick up the medicine pack from the container and convey the medicine pack to a medicine placement unit in which the medicine pack is to be placed, a data reader to read medication-related information from a data retaining medium disposed on at least one of the medicine placement unit, the container, and the medicine pack, and circuitry to control a reading operation by the data reader. In the medication support apparatus, when the data reader fails to read the medication-related information from the data retaining medium, the circuitry changes relative positions of the data retaining medium and the data reader, and causes the data reader to read the medication-related information again from the data retaining medium.

### CROSS-REFERENCE TO RELATED APPLICATION

This patent application is based on and claims priority pursuant to 35 U.S.C. § 119 (a) to Japanese Patent Application No. 2024-074978, filed on May 2, 2024, in the Japan Patent Office, the entire disclosure of which is hereby incorporated by reference herein.

### BACKGROUND

### Technical Field

The present disclosure relates to a medication support apparatus.

### Background Art

In the related art, medication support apparatus have been proposed each of which includes a container to store a plurality of medicine packs, a conveyor that picks up one of the medicine packs from the container and conveys the picked-up medicine pack to a medicine placement unit in which the medicine packs are placed, and a data reader that reads medication-related information from the data retaining medium arranged on at least one of the medicine pack, the container, and the medicine placement unit, and a controller that controls the reading operation by the data reader.

Medication support apparatus have been proposed that the medicine pack that is stored at the bottom of a cartridge is be sucked up and taken out by the suction pad through the opening arranged on the bottom face of a cartridge or container in which a plurality of medicine packs are stacked on top of each other in layers and the medicine pack is conveyed to a subdivision box of the medicine dispensing tray that is an example of a medicine placement unit. When the medicine pack is taken out, conveyed, and placed in the subdivision box in such medication support apparatus, the data retaining medium such as a quick response (QR) code that is arranged on each of the medicine pack, the cartridge, and the subdivision box is read by a data reader such as a code reader. Those items of medication-related information such as the name of a patient who takes medicines and the times of medication, which are read from the QR codes, are stored and such items of medication-related information are used to make comparison when medicines are dispensed. Due to such a configuration, medication errors can be prevented.

### SUMMARY

The present disclosure described herein provides a medication support apparatus that includes a container to store a medicine pack, a conveyor to pick up the medicine pack from the container and convey the medicine pack to a medicine placement unit in which the medicine pack is to be placed, a data reader to read medication-related information from a data retaining medium disposed on at least one of the medicine placement unit, the container, and the medicine pack, and circuitry to control a reading operation by the data reader. In the medication support apparatus, when the data reader fails to read the medication-related information from the data retaining medium, the circuitry changes relative positions of the data retaining medium and the data reader, and causes the data reader to read the medication-related information again from the data retaining medium.

### BRIEF DESCRIPTION OF THE DRAWINGS

A more complete appreciation of embodiments and the many attendant advantages thereof will be readily obtained as the same becomes better understood by reference to the following detailed description when considered in connection with the accompanying drawings.

FIG. 1A is a schematic front view of a medicine dispensing apparatus that makes up a medication support apparatus.

FIG. 1B is a side view of the medicine dispensing apparatus of FIG. 1A.

FIG. 2A is a plan view of a single medicine package.

FIG. 2B is a side view of the single medicine package of FIG. 2A viewed in a direction indicated by an arrow A.

FIG. 2C is a side view of continuous packs where a plurality of medicine packages of FIG. 2A are bound.

FIG. 2D is a plan view of the continuous packs of FIG. 2C.

FIG. 3 is an external perspective view of a medicine dispensing tray attached to the medicine dispensing apparatus of FIG. 1A.

FIG. 4A is a diagram illustrating the attachment of a label with a quick response code (QR CODE) to be placed in a subdivision box of the medicine dispensing tray of FIG. 3.

FIG. 4B is a diagram illustrating how the label of FIG. 4A with a QR CODE is displayed.

FIG. 5A is a vertical sectional view of a cartridge arranged in a medicine dispensing apparatus.

FIG. 5B is a bottom view of the cartridge of FIG. 5A.

FIG. 6A is another vertical sectional view of a cartridge different from that of FIG. 5A.

FIG. 6B is a bottom view of the cartridge of FIG. 6A.

FIG. 7 is a schematic plan sectional view of the attaching and detaching mechanisms for a cartridge, which are arranged on a drawer of a medicine dispensing apparatus.

FIG. 8 is a schematic plan view of cartridges, illustrating the mechanisms for recognizing each one of the cartridges arranged in a drawer.

FIG. 9A is a front view of a carriage of a medicine dispensing apparatus, illustrating a schematic configuration or structure of the carriage.

FIG. 9B is a plan view of the carriage of FIG. 9A.

FIG. 10 is a front view of a carriage, illustrating the progression of the operation of the carriage.

FIG. 11A to FIG. 11F are front views of a carriage, illustrating the progression of the operation of the carriage subsequent to the operation illustrated in FIG. 10.

FIG. 12A to FIG. 12C are front views of a carriage, illustrating the progression of the operation of the carriage subsequent to the operations illustrated in FIG. 11A to FIG. 11F.

FIG. 13 is a front view of a cartridge, illustrating the operation of scanning a QR CODE displayed on the cartridge.

FIG. 14A is a front view of a conveyor, illustrating a schematic configuration of the conveyor provided for a medicine dispensing apparatus.

FIG. 14B is a side view of the conveyor of FIG. 14A, illustrating a schematic configuration of the conveyor.

FIG. 15 is a diagram illustrating the control blocks of a medicine dispensing apparatus.

FIG. 16 is a diagram illustrating the control blocks of a medication support apparatus including a medicine dispensing apparatus.

FIG. 17 is a flowchart of the operation of reading a QR CODE on a cartridge.

FIG. 18A is a diagram illustrating movement patterns of a quick response code reader during a retrying operation.

FIG. 18B is another diagram illustrating movement patterns of a quick response code reader during a retrying operation.

FIG. 19 is a flowchart of the operation of reading a QR CODE on a medicine dispensing tray.

FIG. 20 is still another diagram illustrating movement patterns of a quick response code reader during a retrying operation.

FIG. 21 is still another diagram illustrating movement patterns of a quick response code reader during a retrying operation.

FIG. 22 is a diagram illustrating a configuration or structure with which the QR code reader of FIG. 21 is rotated.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to limit the present disclosure. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing embodiments illustrated in the drawings, specific terminology is employed for the sake of clarity. However, the present disclosure is not intended to be limited to the specific terminology so selected and it is to be understood that each specific element includes all technical equivalents that have the same structure, operate in a similar manner, and achieve a similar result.

A medication support apparatus is described below with reference to the drawings. Firstly, elements of a medicine dispensing apparatus 200 that makes up a medication support apparatus 300 are described.

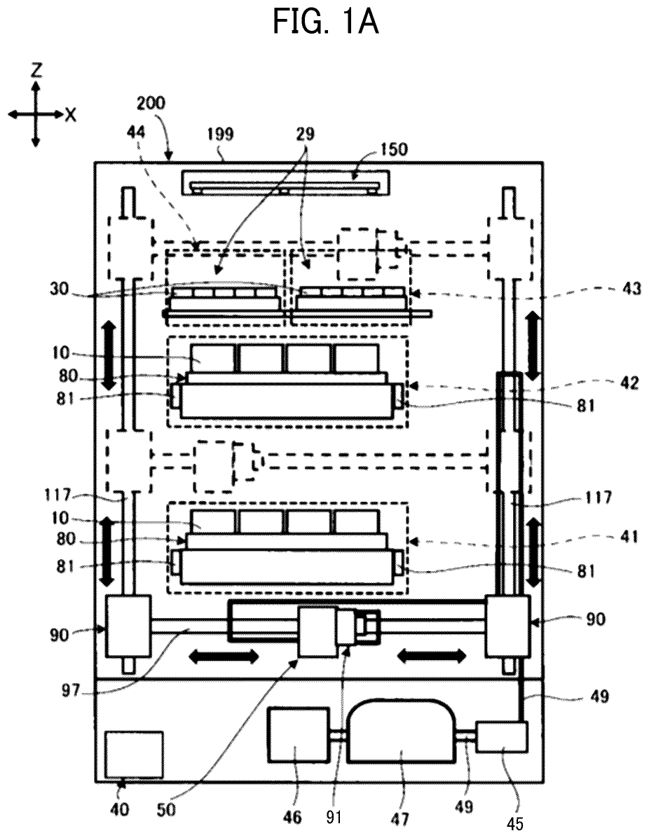

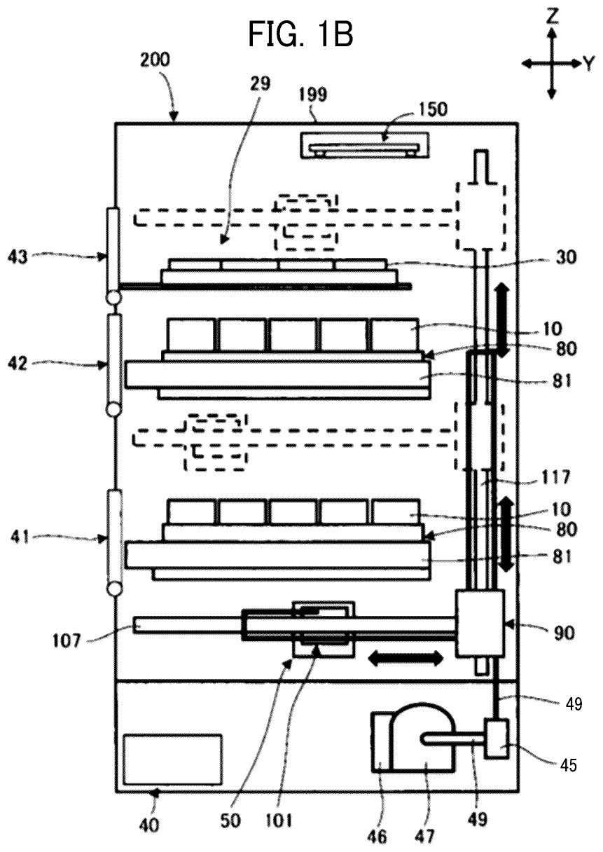

FIG. 1A is a schematic front view of the medicine dispensing apparatus 200, illustrating a basic and overall configuration or structure of the medicine dispensing apparatus 200.

FIG. 1B is a schematic side view of the medicine dispensing apparatus 200 of FIG. 1A, illustrating its configuration or structure.

In FIG. 1A and FIG. 1B, the lateral direction, the depth direction, and the vertical direction of the medicine dispensing apparatus 200 are referred to as the X-axis direction, the Y-axis direction, and the Z-axis direction, respectively. The same applies to the other drawings given below.

As illustrated in FIG. 1A and FIG. 1B, the medicine dispensing apparatus 200 is provided with a cartridge 10 that is also referred to as a container, a cartridge tray 20, a drawer 80, a medicine dispensing tray 30, a carriage 50 that is also referred to as a pickup device, a conveyor 90, and a first gate 41 to a fourth gate 44.

Each one of the cartridges 10 is an example of a container in which a plurality of medicine packages, medicine packs, or continuous packs packing a several kinds of medicines are stored upon being stacked on top of each other in layers. The medicine package according to the present embodiment may be referred to simply as a pack in the following description, and continuous packs will be described later in detail. The multiple cartridges 10 are arranged at a middle portion and a lower portion of the housing 199 of the medicine dispensing apparatus 200 through the cartridge tray 20. The multiple cartridges 10 are attachable to and detachable from the cartridge tray 20. The expression “stored upon being stacked on top of each other in layers” in the present disclosure indicates keeping the packs horizontally in such a manner that the front face is viewable.

The cartridge tray 20 can align and store the multiple cartridges 10, and the cartridge tray 20 serves as a container in which at least one of the multiple cartridges 10 is placed and held.

The cartridges 10 are placed in the pair of drawers 80 through the cartridge tray 20. One of the pair of drawers 80 is arranged at a lower area of the housing 199 of the medicine dispensing apparatus 200, and the other one of the pair of drawers 80 is arranged at a middle area of the housing 199 of the medicine dispensing apparatus 200. In the case of the medicine dispensing apparatus 200 as illustrated in FIG. 1A and FIG. 1B, twenty cartridges 10 (4×5=20) are placed and held in one of cartridge trays 20 of one of the pair of drawers 80. For the sake of explanatory convenience, each one of the multiple drawers 80 may be referred to as the cartridge tray 20 in the following description.

Each of the multiple cartridges 10 is placed and housed in a partitioned lattice-like side wall and bottom wall in the cartridge tray 20. On the bottom wall of the cartridge tray 20 corresponding to the cartridges 10, a rectangular through opening 21 through which a pack can be picked up from below one of the multiple cartridges 10, making use of the elasticity or free deformation of the pack as will be described later in detail, is formed.

The drawer 80 can align and hold the cartridge tray 20. In other words, a pair of slide rails 81 are attached to the outer side wall of the drawer 80, and a rail that engages with the slide rails 81 of the drawer 80 is arranged on the housing 199. Due to such an engagement between the rail of the housing 199 and the slide rail 81, the drawer 80 in which one of the multiple cartridge trays 20 is stored and held can be pulled out from the housing 199.

In the medicine dispensing tray 30, a plurality of subdivision boxes 34 as will be described later in detail are placed and held. Each one of the subdivision boxes 34 is an example of a medicine placement unit in which the prescribed packs conveyed by the conveyor 90 are arranged. As illustrated in FIG. 1A and FIG. 1B, a pair of medicine dispensing trays 30 are arranged above the multiple cartridges 10 mounted on the cartridge tray 20 in the uppermost one of the multiple drawers 80. The areas that include the medicine dispensing trays 30 where the packs are passed to the medicine dispensing tray 30 for automatic medicine dispensing are referred to as medicine dispensing areas 29 in the following description.

The carriage 50 is an example of the pickup device that picks up a specific pack from one of the multiple cartridges 10, and partly serves as the conveyor 90. A portion of the conveyor 90 is an example of a conveyor that conveys the pack picked up from the cartridge 10 by the carriage 50. In other words, the carriage 50 and the conveyor 90 make up a conveyor that picks up a specific pack from a cartridge and conveys it to the subdivision boxes 34 of the medicine dispensing tray 30 that is an example of a medicine placement unit.

Each one of the first gate 41 and the second gate 42 allows one of the multiple cartridges 10 and the cartridge tray 20 to enter and exit the housing 199 through the drawer 80. The multiple cartridges 10 are inserted and set in the housing 199 through each one of the first gate 41 and the second gate 42. More specifically, the open and close door of one of the first gate 41 and the second gate 42 are opened, and the drawer 80 in which the multiple cartridge trays 20 are aligned is drawn out to the front side. By so doing, the multiple cartridges 10 or the multiple cartridge trays 20 are inserted or withdrawn.

The third gate 43 and the fourth gate 44 allow the multiple medicine dispensing trays 30 that are arranged in two rows at the uppermost stage of the medicine dispensing apparatus 200 to enter and exit the housing 199. The third gate 43 and the fourth gate 44 are arranged such that the packs can be taken out immediately after the packs are set or inserted into the subdivision boxes 34 of the medicine dispensing tray 30.

In the medicine dispensing apparatus 200, two medicine dispensing trays 30 are arranged as described above, and as will be described later in detail, a plurality of medicine dispensing trays 30 are arranged for each time of medication such as a time in the morning, a time in the daytime, a time in the evening, and a time before going to bed. The third gate 43 and the fourth gate 44 for the medicine dispensing tray 30 are also arranged for each one of the medicine dispensing trays 30. Due to such a configuration, another different one of the medicine dispensing trays 30 can be taken out even when the medicine dispersing operation is performed on a particular one of the multiple medicine dispensing trays 30.

The multiple cartridge trays 20 as illustrated in FIG. 1A and FIG. 1B are collectively arranged in upper and lower two stages below the multiple medicine dispensing trays 30 arranged uppermost. However, no limitation is intended thereby, and the multiple cartridge trays 20 as illustrated in FIG. 1A and FIG. 1B may collectively be arranged on an upper side or may collectively be arranged on a lower side. Depending on the number of persons in the day-care center or nursing home, the multiple cartridge trays 20 may be arranged in three or more stages to achieve similar advantageous effects.

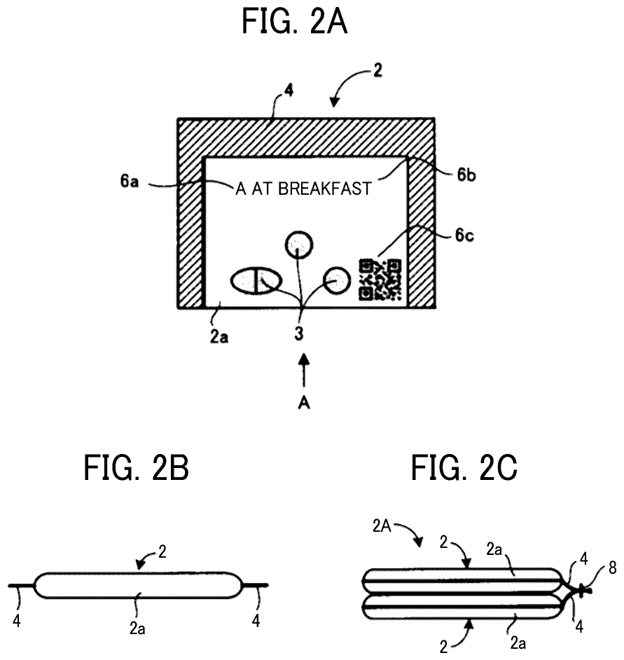

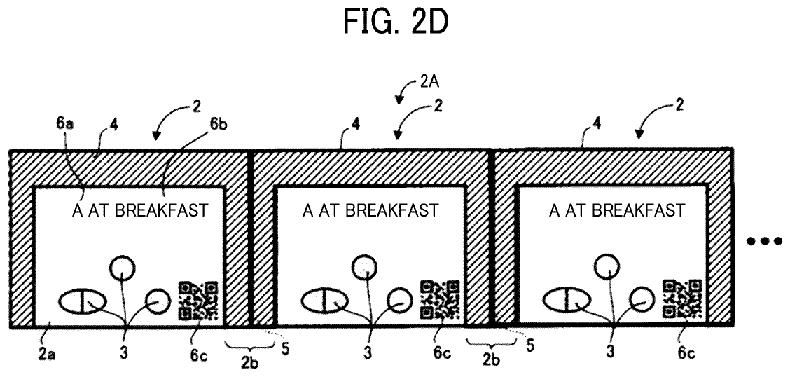

FIG. 2A is a typical plan view of a single medicine package 2.

FIG. 2B a side view of the single medicine package 2 of FIG. 2A viewed in a direction indicated by an arrow A.

FIG. 2C is a side view of the continuous packs 2A in which the medicine packages 2 are stacked on top of each other in layers.

FIG. 2D is a plan view of a typical form of the continuous packs 2A of FIG. 2C.

The medicine pack according to the present embodiment includes, for example, the single medicine package 2 and the continuous packs 2A in which a plurality of medicine packages 2 are stacked on top of each other in layers and bound by, for example, a stapler. In FIG. 2C, two medicine packages 2 are bound as the continuous packs 2A. In the present embodiment, a single medicine package 2 will represent the medicine packages 2 or the continuous packs 2A.

As illustrated in FIG. 2A, one medicine package 2 is formed of, for example, a resin film, and medicines 3 such as capsules or tablets are packed in small quantities. The medicine package 2 includes a bag 2a that covers the medicines 3 and a pressure-bonded portion 4 in which three sides of the bag 2a are pressure-bonded or welded. The pressure-bonded portion 4 is hatched in FIG. 2A and FIG. 2D. Typically, the side of the medicine package 2 on the bag 2a side is folded into two, and the medicines 3 are packed therebetween. The pressure-bonded portion 4 forms a leakage-preventing portion that prevents the medicines 3 from slipping out from the bag 2a. Typically, the medicines 3 in one medicine package 2 is a one-time dosage for a patient who takes medicines.

The medicine package 2 is dispensed and prepared by a drug-dispensing machine installed in, for example, a pharmacy. The dispensing sheets that serve as packages and are used for dispensing the medicines are rolled long-length sheets, and are perforated between packs. The dispensing sheets are rolled in an overlapping manner, and the medicines 3 to be taken are packed in the space between the sheets. The medicines 3 for a required number of doses are divided in small quantities, and packed into the multiple medicine packages 2 that form a continuous sheet. The three sides other than the folded portion of each one of the multiple medicine packages 2 around the medicines 3 for a single dose are sealed in turn by the pressure-bonded portion 4. The multiple medicine packages 2 that form such a continuous sheet may be referred to as continuous packs 2A in the following description.

In the continuous packs 2A that are described with reference to FIG. 2D, the multiple medicine packages 2 are coupled to each other and laid like a belt. In the present embodiment described with reference to FIG. 2D, the medicines 3 for three doses are illustrated. The continuous packs 2A are typical form of drug or medicine that is given or sold at a pharmacy or the like to, for example, a user such as a person who actually takes the medicine 3 in the medicine package 2 and a personal care attendant or assistant who helps or assists the user to take medication, or a staff or the like including a pharmacist, a nurse practitioner, a care manager, or a medication assistant of, for example, various kinds of day-care center, nursing home, or medical institution. For the sake of explanatory convenience, each one of the packs is filled with the medicines 3 of the same form in the following description. In FIG. 2C, by way of example, each one of the packs is filled with the same capsule and the same tablets. However, no limitation is indicated thereby. As a matter of course, each one of the packs may be filled with different types of medicines depending on, for example, the usage or purposes of the medication.

In the present embodiment described with reference to FIG. 2A, FIG. 2B, FIG. 2C, and FIG. 2D, the medicine package 2 has a rectangular shape in a plan view, and a packaging method in which three sides are crimped and sealed as in the present embodiment is called three-sided packaging in the related art. Most of the drug-dispensing machines available on the market make packs using the three-sided packaging method.

The pressure-bonded portion 4 has a band-like width of about 10 to 15 millimeters (mm), and has higher rigidity than the portion of the bag 2a that is a transparent or semitransparent film where the medicines 3 can be visually recognized therethrough. In the generation or dispensing by a drug-dispensing machine, a boundary portion 2b that is implemented by perforation 5 is formed in the center of the pressure-bonded portion 4 between a pair of the multiple medicine packages 2 making up the continuous packs 2A. The multiple medicine packages 2 are adjacent to each other in an upstream-to-downstream direction. For example, a user who is not handicapped in the hand can obtain one medicine package 2 by tearing off at the perforation 5 by hand or by cutting near the perforation 5 with scissors or a dedicated cutter.

As illustrated in FIG. 2C, continuous packs 2A may be used. The continuous packs 2A are formed by fastening multiple medicine packages 2 at the center of the three sides of the pressure-bonded portions 4 by stapling 8 (see FIG. 2C) or the like. In FIG. 2C, two medicine packages 2 are fastened together. For example, the continuous packs 2A may be formed by taping a plurality of packs together. Alternatively, the continuous packs 2A may be, for example, packs of Chinese herbal medicines or sheets of blister packs that are combined together.

As medication-related information such as the name of a patient who takes medicines and the times of medication, the medication-related information is added to the surface of the bag 2a of the medicine package 2. More specifically, texts 6a that indicate the medication-related information such as the name of a patient who takes the medicine 3 in the medicine package 2, texts 6b that indicate the medication-related information such as the times of medication at which the medicine 3 is taken, and the data retaining medium such as a quick response (QR) code that is a two-dimensional code obtained by encoding the medication-related information including the name of a patient who takes medicines and the times of medication are arranged on the medicine package 2 as illustrated in FIG. 2A, FIG. 2B, FIG. 2C, and FIG. 2D. The texts 6a and 6b and the QR code 6c, which are textual medication-related information, are added to the medicine package 2 as illustrated in FIG. 2A, FIG. 2B, FIG. 2C, and FIG. 2D. However, no limitation is intended thereby, and one of the textual information and the QR code may be added. Alternatively, for example, a data retaining medium such as a recording medium including a radiofrequency identification (RFID) tag that is used when tag information is read using a one-dimensional coded image such as a bar code or short-range radio may be used.

Further, the medication-related information may be, for example, the type of the medicine or the shape of the medicine prescribed in a pack, the number of tablets, and the images or texts printed on the medicine itself. As the medication-related information, only individual information may be acquired and used, or items of information may be acquired and used in combination. For example, if confirmation of the patient who takes medicines is required, the information about the name of the patient who takes medicines is sufficient. If it is desired to prevent forgetting to take an important medicine, the information of the number of tablets of the medicine and the shape of the medicine in the pack is confirmed together with the information of the patient who takes medicines. The medication-related information includes, for example, at least one of the name of a patient who takes medicines, the times of medication at which the medicines in a pack are to be taken, and the number of tablets and types of the medicines prescribed in the pack.

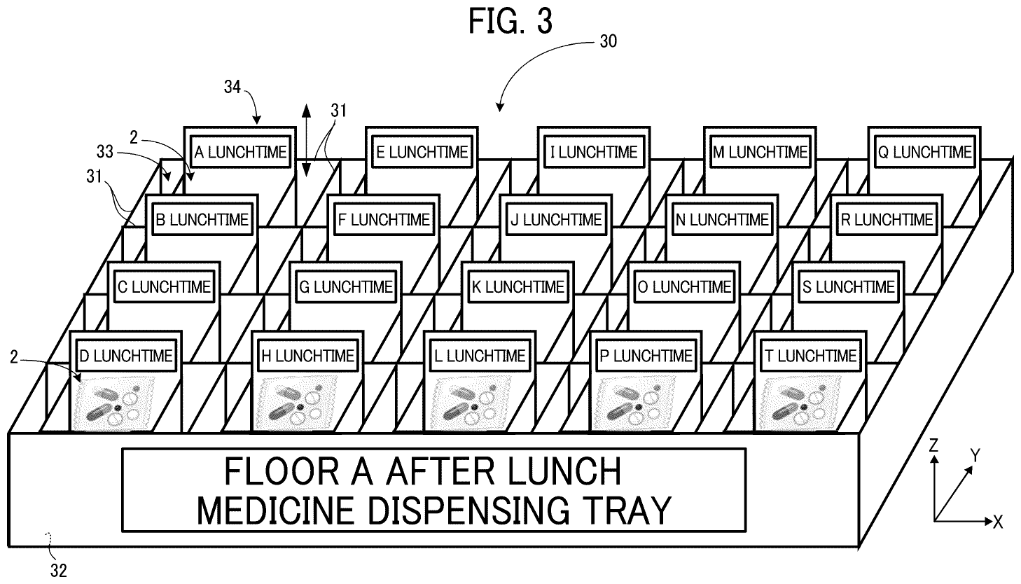

FIG. 3 is an external perspective view of the medicine dispensing tray 30, illustrating a configuration of the medicine dispensing tray 30.

As illustrated in FIG. 3, each one of the multiple medicine dispensing trays 30 has partition walls 31 that serve as dividers for arranging prescribed packs, and is partitioned by four upright partition walls 31. The twenty rooms 33 that are formed in each one of the multiple medicine dispensing trays 30 can be expressed as the components of a matrix including five columns in the X-axis direction or the line feed direction and four rows in the Y-axis direction or the character feed direction. As a result, each one of the twenty rooms 33 of the medicine dispensing trays 30 can be uniquely positioned based on the components and addresses of the matrix of five columns and four rows. Furthermore, each one of the multiple medicine dispensing trays 30 has a bottom wall 32 on which the multiple medicine packages 2 are placed. As described above, each one of the medicine dispensing trays 30 is arranged such that specific one of the multiple packs arranged in specific one of the rooms 33 will be placed in specific one of the rooms 33 with reliability by the multiple partition walls 31, which are four partition walls in the present embodiment, and the bottom wall 32 in common, without being mixed up with packs in different one of the rooms 33 or dropping off from the bottom wall 32.

In the medicine dispensing tray 30 as illustrated in FIG. 3, “FLOOR A AFTER LUNCH MEDICINE DISPENSING TRAY” displayed on the front outer wall indicates that the tray is the medicine dispensing tray 30 in which the multiple packs to be taken after lunch by patients who take medicines and reside in the same floor A of, for example, a day-care center or nursing home are arranged.

FIG. 3 illustrates one of the multiple medicine dispensing trays 30 where a subdivision box 34 attachable to and detachable from each one of the multiple rooms 33 is used. For example, the multiple subdivision boxes 34 hold the multiple medicine packages 2 filled with the medicines 3 to be taken by twenty residents A to T after lunch in a day-care center or nursing home. In other words, one of the multiple medicine dispensing trays 30 illustrated in FIG. 3 is used to arrange prescribed packs in a predetermined or specific one of the multiple rooms 33 partitioned by dividers through the multiple subdivision boxes 34. The operation of placing the multiple medicine packages 2 in one of the multiple medicine dispensing trays 30 is briefly described later with a case in which the multiple subdivision boxes 34 are not used. In such cases, each one of the multiple rooms 33 of one of the multiple medicine dispensing trays 30 serves as a medicine placement unit.

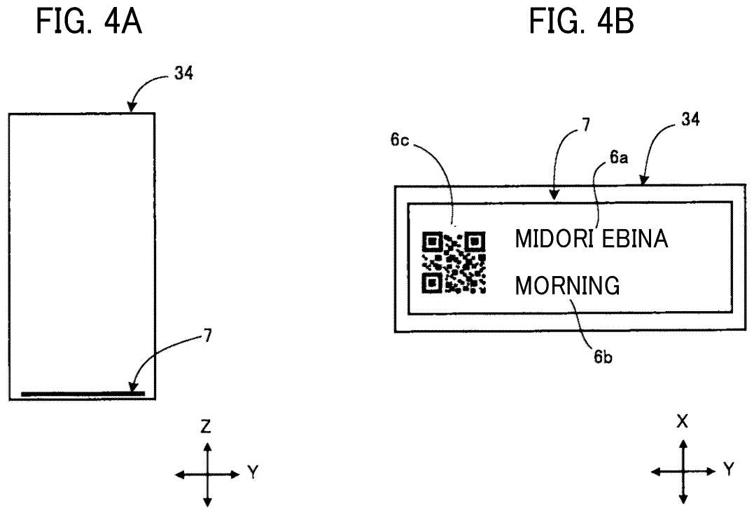

FIG. 4A is a diagram illustrating the attachment of the label 7 with a QR code to be placed in the subdivision box 34 used for the medicine dispensing tray 30.

FIG. 4B is a diagram illustrating how a label 7 with a QR CODE is displayed.

In order to specify the place to which one of the multiple medicine packages 2 picked up from one of the multiple cartridges 10 is to be dispensed, the label 7 with a QR code on which the texts 6a that indicate the name of a patient who takes medicines, the texts 6b that indicate the times of medication, and the QR code 6c in which the name of a patient who takes medicines or the time of medication are encoded are printed is pasted on the inner bottom face of one of the multiple subdivision boxes 34 of the medicine dispensing tray 30.

The QR CODE of the label 7 with a QR code is read by the lower QR code reader 67 that is an example of a medication-related information reader unit or a data reader that will be described later in detail, and the coordinates of the X position and the Y position, which are the information about the position of the carriage 50, are linked to a QR CODE that indicates the name of a patient who takes medicines and the times of medication. By so doing, the pack that is picked up from one of the multiple cartridges 10 can be dispensed to a desired position. For example, label 7 with a QR code may be directly attached to the subdivision box 34 in the form of a seal, or may be attached to an independently-prepared plate and arranged in the subdivision box 34.

A label 7 with the QR code 6c may be pasted to each one of the rooms 33 of one of the medicine dispensing trays 30. When the subdivision box 34 is not to be used, a plate as mentioned above may be arranged on each one of the rooms 33. When the subdivision box 34 is used, the subdivision box 34 in which the multiple medicine packages 2 are stored can be picked up from the medicine dispensing tray 30, and a proper medicine package 2 can be passed to an occupant or patient who takes medicines. Accordingly, there is little worry about taking a wrong pack or dropping the pack.

In each one of the multiple rooms 33 of the multiple medicine dispensing trays 30, a setting position or inserting position is determined for each patient who takes medicines depending on the type of medicines in the pack to be taken. In other words, the multiple rooms 33 in one of the multiple medicine dispensing trays 30 may be allocated to patients who take medicines at the same time. In a case where a specific patient who is to take medicines does not take a medicine at a specific time of medication, the arrangement can be made such that a pack is not given to such a specific patient at the specific time of medication.

However, no limitation is intended by the medicine dispensing trays 30 described above. Each one of the multiple rooms 33 of one of the medicine dispensing trays 30 may be allocated for each time of medication of each patient who takes medicines. More specifically, in such an alternative embodiment of the present disclosure, the multiple rooms 33 may be allocated to each of the patients who take medicines in view of the time of medication of each one of the multiple medicine packages 2 to be taken in the morning, in the daytime, in the evening, or before going to bed. The medicine dispensing trays 30 of such cases may be managed on a room-by-room basis or a floor-by-floor basis in day-care centers or nursing homes where patients who take medicines reside, and the multiple medicine packages 2 for that day or a couple of days may be dispersed in advance to the multiple medicine dispensing trays 30. allocating the rooms 33 based on each time of medication such as a time in the morning, a time in the daytime, a time in the evening, and a time before going to bed can prevent the time of medication from being mistaken by patients who take medicines.

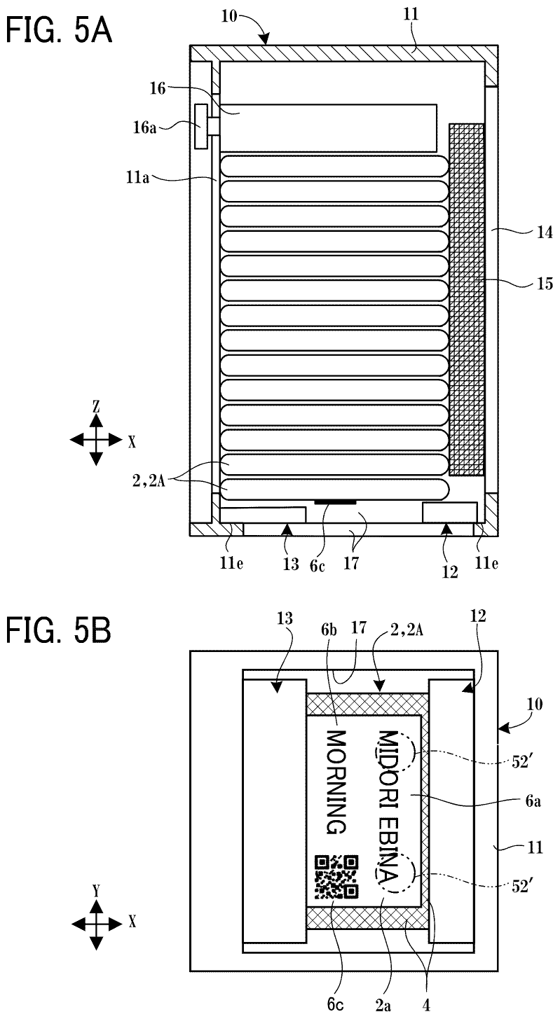

FIG. 5A is a vertical sectional view of the cartridge 10.

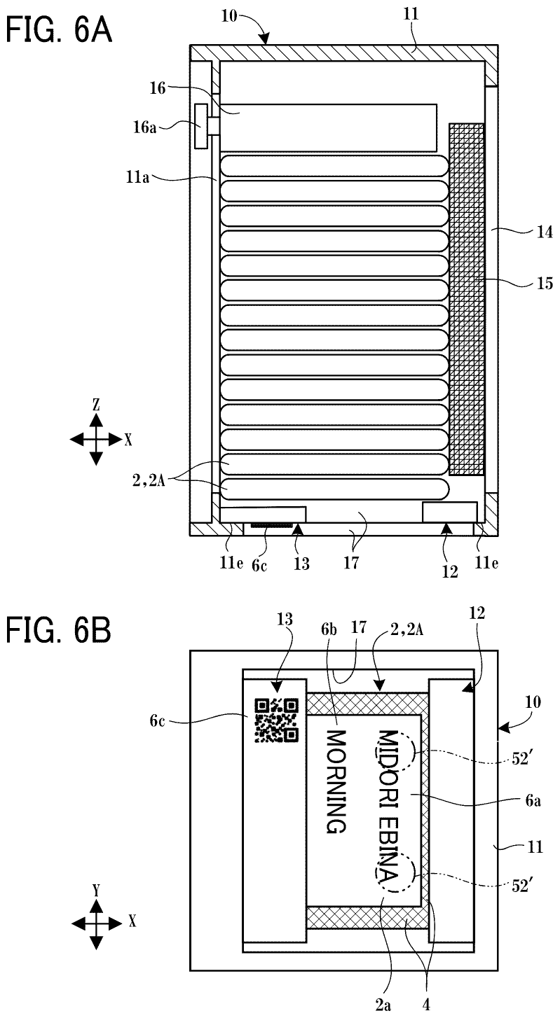

FIG. 6A is another vertical sectional view of one of the multiple cartridges 10 different from that of FIG. 5A.

FIG. 5B is a bottom view of the cartridge 10 of FIG. 5A.

FIG. 6B is a bottom view of the cartridge 10 of FIG. 6A.

In order to simplify the drawing, the illustration of the pressure-bonded portions 4 (see FIG. 2A, FIG. 2B, FIG. 2C, and FIG. 2D) of the multiple medicine packages 2 stored in one of the multiple cartridges 10 is omitted in the pair of vertical sections of FIG. 5A and FIG. 6A, and the medicine packages 2 are schematically illustrated in an enlarged and exaggerated manner. For the same purpose, the hatching of the cross sections of the supporters such as the right support portion 12 and the left support portion 13 is also omitted. One of the multiple cartridges 10 as illustrated in FIG. 5A and FIG. 5B is equivalent to one of the multiple cartridges 10 as illustrated in FIG. 6A and FIG. 6B in terms of, for example, the shape. The display position and the display member of the QR code 6c are different between FIG. 5A and FIG. 6A and between FIG. 5B and FIG. 6B. The configuration or structure in terms of, for example, the shape is described with reference to FIG. 5A and FIG. 5B.

For example, each one of the multiple cartridges 10 includes a casing 11, a lid 14, a pack pickup slot 17, a movable board 16, a pack posture keeper 15, and a right support portion 12 and a left support portion 13 each of which serves as a support portion.

The casing 11 stores, for example, multiple medicine packages 2 or the continuous packs 2A. In the following description, a single medicine package 2 will represent such multiple medicine packages 2 or continuous packs 2A. For example, the casing 11 is integrally or separately formed using resin. The lid 14 enables the multiple medicine packages 2 to be loaded or unloaded. The pack pickup slot 17 is formed in a lower portion or a bottom portion of the casing 11, and is used to pick up the medicine package 2 in one of the multiple cartridges 10. Moreover, the pack pickup slot 17 allows the medicine package 2, which is picked up from one of the multiple cartridges 10 by the carriage 50, to pass therethrough.

The movable board 16 prevents the medicine package 2 from falling out, and moves the lowermost one of the medicine packages 2 to a position close to the pack pickup slot 17 after the first one of the maximum number of medicine packages 2 that can be stored in the casing 11 is picked up. The pack posture keeper 15 keeps the posture of the medicine package 2. The right support portion 12 and the left support portion 13 also support or hold the medicine package 2 in the casing 11.

In the present embodiment, the to-be-picked-up portion of one of the multiple medicine packages 2 to be picked up from one of the multiple cartridges 10 by the carriage 50 is at a lower portion or bottom portion of the corresponding one of the multiple cartridges 10. In other words, the to-be-picked-up portion includes the pack pickup slot 17, and the right support portion 12 and the left support portion 13 that serve as a pair of support portions or supporting member and support, at multiple points, one of the multiple medicine packages 2 to be picked up from one of the multiple cartridges 10.

The right support portion 12 and the left support portion 13 are configured to allow one of the multiple medicine packages 2 to pass through when one of the multiple medicine packages 2 is picked up from one of the multiple cartridges 10 by the carriage 50. On the other hand, when any one of the multiple medicine packages 2 is not to be picked up from one of the multiple cartridges 10, the multiple medicine packages 2 are to be stored and held in the casing 11. In order to achieve that, the right support portion 12 and the left support portion 13 are configured to restrict the passage of one of the multiple medicine packages 2

As described above, the right support portion 12 and the left support portion 13 serve as a pair of support portions that support or hold the multiple medicine packages 2 in the one of the multiple cartridges 10, and each one of the right support portion 12 and the left support portion 13 is fixed and immovable such that one of the multiple medicine packages 2 can be picked up in a stable manner from one of the multiple cartridges 10 by the carriage 50. The right support portion 12 and the left support portion 13 are a pair of fixation members that are fixed or attached to the pair of bottom-wall inner surfaces 11e of the right bottom-wall edge and left bottom-wall edge of the pack pickup slot 17, respectively.

The pack pickup slot 17 has both a function to allow the suction pad 52 of the carriage 50 to pass therethrough in order to pick up one of the multiple medicine packages 2 and a function to allow the picked-up medicine package 2 and the suction pad 52 to pass therethrough. In other words, the pack pickup slot 17 and the above right bottom-wall edge and left bottom-wall edge that are arranged so as to surround the pack pickup slot 17 together serve as a pack passing-through portion according to the present embodiment.

In one of the multiple cartridges 10 illustrated in FIG. 5A and FIG. 5B, a pair of positions 52′ at which the pair of suction pads 52 adsorb or suck up one of the multiple medicine packages 2 stored in one of the multiple cartridges 10 are indicated by a pair of ring-shaped dot-dot-dash lines as illustrated in FIG. 5B. Such a pair of positions may be referred to as a pair of suction pad positions in the following description. The right support portion 12 and the left support portion 13 support the multiple medicine packages 2 in one of the multiple cartridges 10 such that the multiple medicine packages 2 in one of the multiple cartridges 10 do not fall off from the pack pickup slot 17. As will be described later in detail in regard to the operation of the carriage 50, when the medicine package 2 at the bottom of the cartridge 10 is sucked and picked up by the pair of suction pads 52, one of the multiple medicine packages 2 is sucked by the pair of suction pads 52 at a pair of suction-pad positions in the Y-axis direction near both ends of the right support portion 12. When the lowermost one of the multiple medicine packages 2 is picked up from one of the multiple cartridges 10 by the pair of suction pads 52, the pair of suction pads 52 passe near both ends of the right support portion 12 in the Y-axis direction to suck and hold one of the multiple medicine packages 2.

As illustrated in FIG. 5B, a pair of positions 52′ at which the pair of suction pads 52 contact the medicine package are arranged near both ends of the right support portion 12 in the Y-axis direction. Due to such a configuration, the possibility of an error in which the suction by the pair of suction pads 52 is disabled can be avoided and prevented, and the picking up operation can successfully be done. In other words, as both ends of the multiple medicine packages 2 in the Y-axis direction are sucked by the pair of suction pads 52, the bag 2a of the medicine package 2, which is made of film, is stretched and can withstand the deformation. Accordingly, both reliable support or holding of the multiple medicine packages 2 in one of the multiple cartridges 10 and smooth removal of one of the multiple medicine packages 2 can be achieved.

The pack posture keeper 15 is formed of sponge rubber having appropriate elasticity. The movable board 16 is made of, for example, resin or metal. The pack posture keeper 15 and the movable board 16 hold the posture of the multiple medicine packages 2 under normal operating conditions in the casing 11. As explicitly illustrated in FIG. 5A, the posture of the multiple medicine packages 2 is held orderly in the Z-axis direction in a substantially horizontal state. In order to achieve the above-described function, the movable board 16 is arranged to move at least one of the multiple medicine packages 2 left in the casing 11 toward the pack pickup slot 17 as moving downward in the casing 11 in the Z-axis direction by its own weight.

As illustrated in FIG. 5A, a long groove 11a that extends in the Z-axis direction with predetermined width in the X-axis direction is formed in the side wall of the casing 11. A shaft 16a with a flange is arranged at one end of the movable board 16 so as to protrude from the long groove 11a. As the shaft 16a of the movable board 16 is guided in the Z-axis direction parallel to the long groove 11a, the posture of the multiple medicine packages 2 can be held in the Z-axis direction. In FIG. 5A and FIG. 5B, the multiple medicine packages 2 in the multiple cartridges 10 are stacked on top of each other in layers in a substantially horizontal state. However, in actuality, left portions of the medicine packages 2 in FIG. 5A and FIG. 5B filled with the medicines 3 are expanding.

A set of the multiple medicine packages 2 are orderly stored in the casing 11 toward the upper side from the pack pickup slot 17 on the right support portion 12 and the left support portion 13. The timing at which the multiple medicine packages 2 are supplied into one of the multiple cartridges 10 may be, for example, the timing at which a patient who takes medicines or occupant is examined in a day-care center or nursing home, which is typically once a two weeks, or the timing at which the multiple medicine packages 2 in one of the multiple cartridges 10 run out. When some medicine packages 2 are left in one of the multiple cartridges 10 at the time of replenishment, such replenishment is continued from the back of the remaining medicine packages 2. Under normal operating conditions, the above-described setting of the multiple medicine packages 2 into one of the multiple cartridges 10 and the replenishment of the multiple medicine packages 2 are done by a staff or the like in a day-care center or nursing home. However, no limitation is indicated thereby. In particular, in configurations where cartridges are used instead of containers and setting or replenishment of the medicine packages 2 are done automatically, the setting or replenishment of the medicine packages 2 may be done differently.

The lid 14 is used by a staff or the like who works at a day-care center or nursing home to enable loading or unloading of the multiple medicine packages 2 stored in one of the multiple cartridges 10, and as illustrated in FIG. 5A, is formed with wide length in the Z-axis direction of the casing 11 and has a predetermined opening width.

As illustrated in FIG. 5B, the types of the multiple medicine packages 2 in one of the multiple cartridges 10 are sorted or divided based on the timings at which medicines are taken. For example, one cartridge contains medicines to be taken in fourteen days in the morning by, for example, Midori Ebina (Ms. A). In view of the above circumstances, if Ms. Midori Ebina (A) takes the medicines not only in the morning but also in the daytime or in the evening, or before going to bed, four cartridges 10 are required in total.

However, no limitation is indicated thereby. For example, in an alternative embodiment of the present disclosure, a single cartridge 10 may be prepared for each person or patient who takes medicines. In such cases, for example, a pack to be used in the morning on day one, a pack to be used at lunchtime on day one, a pack to be used in the evening on day one, a pack to be used before going to bed on day one, a pack to be used in the morning on day two, a pack to be used at lunchtime on day two, and a pack to be used in the evening on day two may be stored in the order listed upward from the pack pickup slot 17 parallel to the direction in which packs are taken out from the multiple cartridges 10.

In the present embodiment, the right support portion 12 and the left support portion 13 are fixed to the bottom-wall inner surface 11e of the pack pickup slot 17 of the casing 11 such that one of the multiple medicine packages 2 can be picked up in a stable manner from one of the multiple cartridges 10 by the carriage 50. In other words, the right support portion 12 and the left support portion 13 are fixed when the right support portion 12 and the left support portion 13 hold both ends of the medicine pack such as the medicine package 2 or the continuous packs 2A around the pack pickup slot 17 arranged at the lower portion of one of the multiple cartridges 10.

The medicine package 2 that is stored in the cartridge 10 is supported by a right support portion 12 and a left support portion 13 so as not to drop. The right support portion 12 supports a right end where the medicine package 2 is sucked up, and the left support portion 13 supports a left end on the other side. The right support portion 12 and the left support portion 13 are different in the length of the portion that support the multiple medicine packages 2, and the length of portion of the right support portion 12 that support the multiple medicine packages 2 is shorter than that of the left support portion 13. When the lowermost one of the multiple medicine packages 2 stored in one of the multiple cartridges 10 is adsorbed or sucked by the suction pad 52 and is from the cartridge 10, the medicine pack such as the medicine packages 2 is bent or freely deformed due to its elasticity. Accordingly, the medicine pack can easily be pulled out.

In the above configuration, the pair of support portions including the right support portion 12 and the left support portion 13 are of fixed type. Accordingly, the front end of the next one of the multiple medicine packages 2 to be taken out can be reliably held and does not jump out or fall off together with one of the multiple medicine packages 2 that is being taken out. As the pair of support portions including the right support portion 12 and the left support portion 13 do not swing or rotate, the medicine package 2 are held with high stability with no deformation or the like due to unintentional nipping or pressing in the returning operation.

As illustrated in FIG. 5A and FIG. 5B, the texts 6a and 6b or the QR code 6c that are displayed on a medicine pack such as the medicine package 2 or the continuous packs 2A are exposed through the pack pickup slot 17 of one of the multiple cartridges 10. The QR code 6c of the medicine pack can be read by an upper QR code reader 66 mounted on the carriage 50. For the sake of explanatory convenience, in FIG. 5A and FIG. 5B, the QR code 6c is displayed only on, for example, the medicine package 2 or the continuous packs 2A that are stored at the bottom of one of the multiple cartridges 10, but the QR code 6c is displayed on, for example, all the medicine packages 2 or the continuous packs 2A that are stored in one of the multiple cartridges 10.

For example, when a drug-dispensing machine that makes, for example, the medicine package 2, cannot print coded image such as the QR code 6c on a medicine pack such as the medicine package 2 or the continuous packs 2A, the QR CODE may be arranged as illustrated in FIG. 6A and FIG. 6B. In other words, as illustrated in FIG. 6A and FIG. 6B, the label with QR code 6c is pasted to the bottom face of the left support portion 13 close to the pack pickup slot 17. As a result, the medication-related information of the medicine pack such as the medicine packages 2 or the continuous packs 2A that is stored in one of the multiple cartridges 10 can be obtained. In order to obtain the medication-related information, the QR code 6c may directly be printed on the cartridge 10 instead of pasting a label of the QR code 6c.

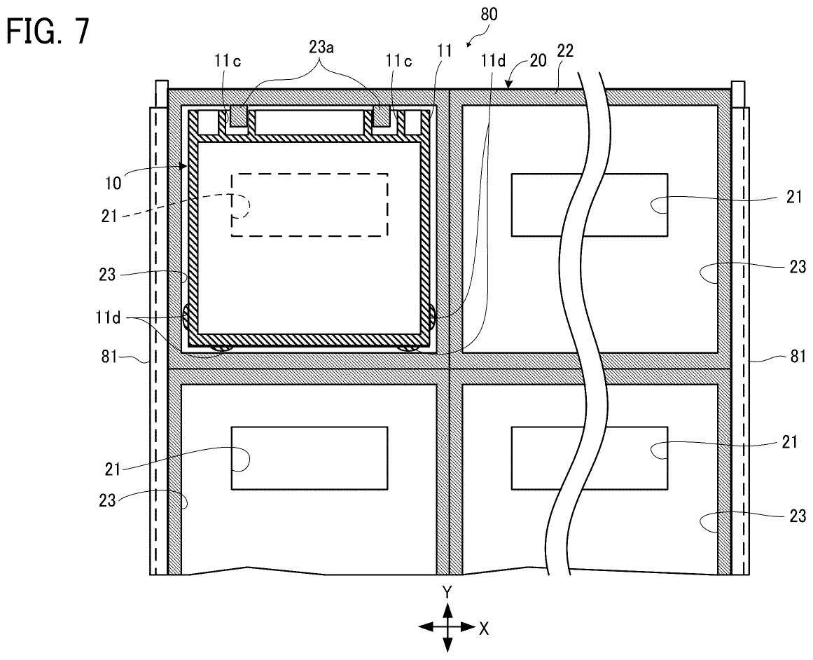

FIG. 7 is a schematic plan sectional view of the attaching and detaching mechanisms for the cartridge 10, which are arranged on the drawer 80.

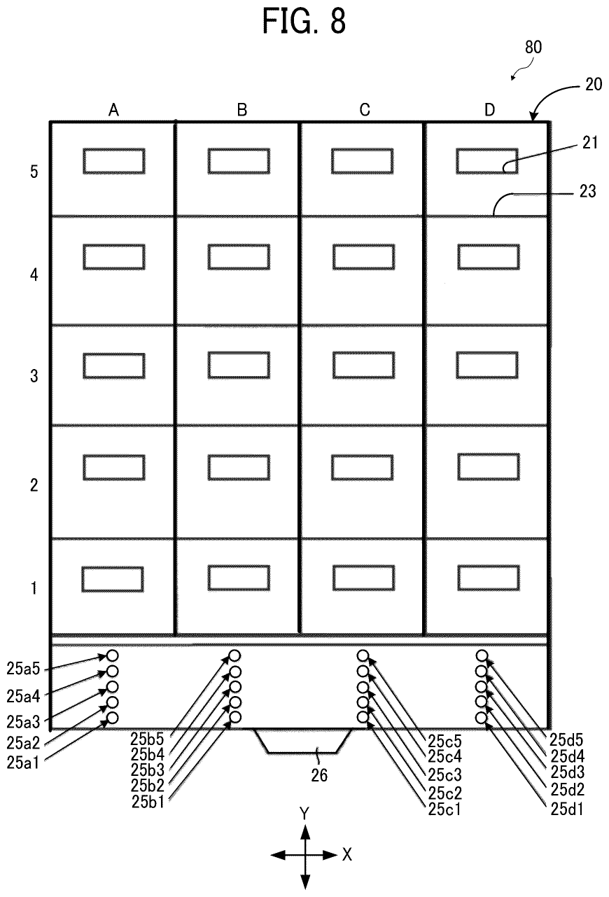

FIG. 8 is a schematic plan view of the cartridges 10, illustrating the mechanisms for recognizing each one of the cartridges, which are arranged in the drawer 80.

As illustrated in FIG. 7, the drawer 80 is configured to allow the multiple cartridges 10 to be attachable and detachable through the cartridge tray 20. The drawer 80 is integrally formed with the cartridge tray 20 to hold the cartridge tray 20. The casing 22 of the cartridge tray 20 in the drawer 80 is provided with a pair of slide rails 81 on the right and left outer side walls, respectively, and each one of the pair of slide rails 81 is slidable with one of the multiple rails provided for the housing 199 (see FIG. 1A and FIG. 1B). Due to such a configuration, the multiple cartridge trays 20 in the drawer 80 can be attached or detached by being pulled out from the housing 199 through the engagement between the slide rail 81 and the one of the multiple rails of the housing 199.

As illustrated in FIG. 7, one of the multiple cartridges 10 is attached to and detached from the cartridge tray 20 in the drawer 80 through the engagement and disengagement between a pair of concave portions 11c on the external wall of the casing 11 of the cartridge 10 and a pair of convex portions 23a that are formed on the inner wall of the casing 22 of the drawer 80 and protrude inwardly and the engagement and disengagement between the inner wall of the casing 22 and four hemispherical protrusions 11d on the external wall of the casing 11. With the above-described attaching and detaching mechanism of the drawer 80, the multiple cartridges 10 can be attached or detached easily and with good operability.

In the above embodiments of the present disclosure, attachment and detachment are enabled by the coupling or engagement of concave and convex portions. However, no limitation is intended thereby, and an elastic member may be arranged in the gap between the inner wall of the casing 22 and the external wall of the casing 11 to enable attachment and detachment. Alternatively, a configuration or structure using magnetic force or a snap-fit assembly method may enable attachment and detachment. As illustrated in FIG. 7 and FIG. 8, a rectangular through opening 21 that communicates with the pack pickup slot 17 of one of the multiple cartridges 10 when each one of the multiple cartridges 10 is attached to each container 23 of the cartridge tray 20 is formed on the bottom wall of the cartridge tray 20 of the drawer 80.

As illustrated in FIG. 8, the cartridge tray 20 of the drawer 80 has containers 23 in which twenty cartridges 10 are stored. Each tray has four columns of A to D in the horizontal direction, and has five rows of 1 to 5 in the vertical direction. As illustrated in FIG. 8, the drawer 80 is provided with an information display device such as a plurality of light-emitting diodes (LEDs) 25al to 25d5 around a grip 26 that is held by hand to insert or withdraw the drawer 80. Due to such a configuration, the arrangement of the multiple cartridges 10 can easily be figured out. Detection units such as sensors or switches are provided for the containers 23 to recognize whether the cartridge 10 is present electrically or automatically, and the information display device provides notification of the result of recognition. More specifically, due to such a configuration, at what position one of the multiple cartridges 10 in focus is placed in the cartridge tray 20 of the drawer 80 can easily be figured out at a glance.

In FIG. 8, the light-emitting diode (LED) 25al is used to indicate the presence or absence of one of the multiple cartridges 10 attached to or detached from a storage unit A1 of the cartridge tray 20. The storage unit A1 indicates a position or partition that is uniquely determined in the vertical columns and horizontal rows. In a similar manner to the above, the LED 25a2 corresponds to a portion of the storage unit A2 of the cartridge tray 20, and the LED 25a3 corresponds to a portion of the storage unit A3 of the cartridge tray 20. Moreover, the LED 25a4 corresponds to a portion of the storage unit A4 of the cartridge tray 20, and the LED 25a5 corresponds to a portion of the storage unit A5 of the cartridge tray 20. In a similar manner to the above, as illustrated in FIG. 8, each one of three columns of B to D and five rows of 1 to 5 of the containers is provided with an LED that indicates whether one of the multiple cartridges 10, which is attached to and detached from one of the containers, is present.

The container may be provided with for example, a number, a bar code, a QR CODE, or a non-contact integrated circuit (IC) tag such that each one of the containers will be identifiable. It is desired that the system be programmed to remember what container stores whose medicines. Subsequently, the drawer 80 to which the multiple containers are attached is set in the housing 199 of the medicine dispensing apparatus 200, and each one of the multiple containers is identified by the medicine dispensing apparatus 200. Due to such a configuration, a desired pack can be picked up by the medicine dispensing apparatus 200 without causing any errors.

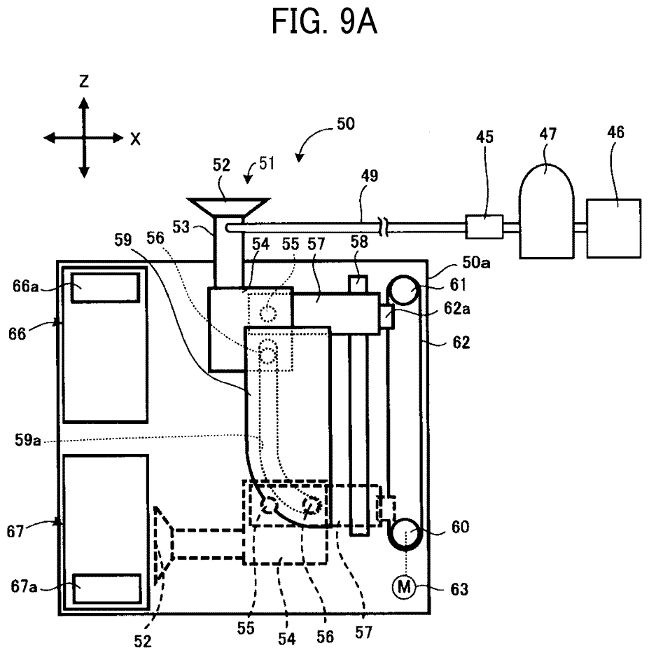

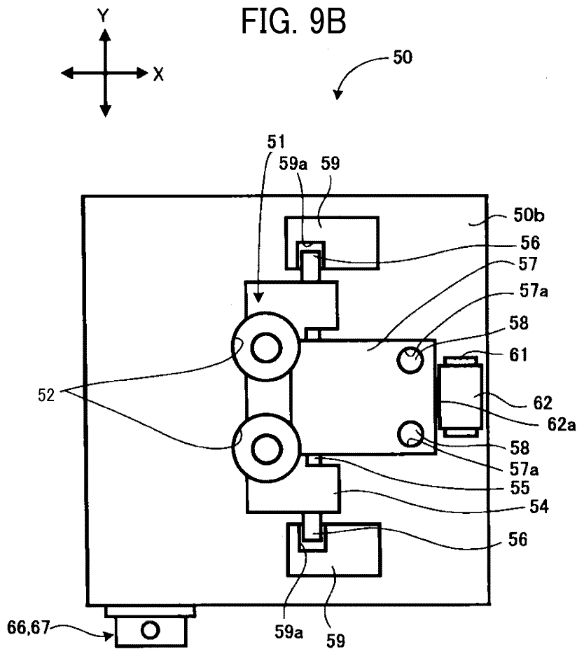

FIG. 9A is a front view of a carriage 50 illustrating a schematic configuration or structure of the carriage 50.

FIG. 9B is a plan view of the carriage 50 of FIG. 9A.

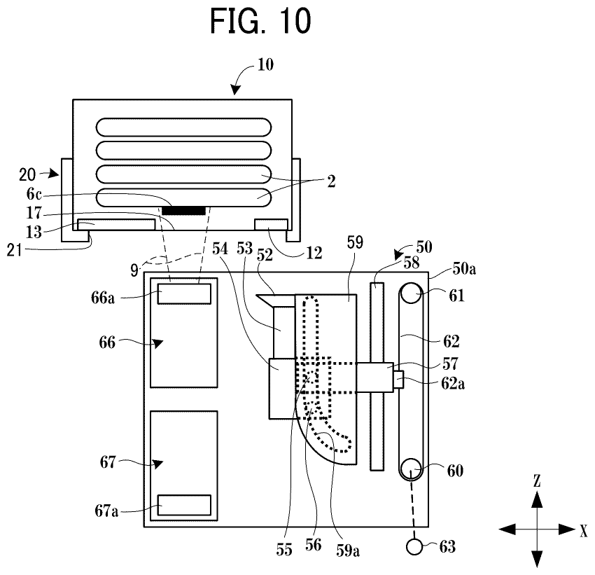

FIG. 10 to FIG. 12C are front views of the carriage 50, illustrating the progression of the operation of the carriage 50.

In order to simplify the drawing, how elements such as a negative-pressure generator 45 are connected to the carriage 50 is illustrated in FIG. 9A.

As illustrated in FIG. 9A and FIG. 9B, the carriage 50 includes a suction device 51 that picks up and holds one of the multiple medicine packages 2 from one of the multiple cartridges 10. The suction device 51 has a function to such up and separate the medicine package 2. When the medicine package 2 is to be sucked up, the suction device 51 has a function to suck up the medicine package 2 using the air under negative pressure generated by the negative-pressure generator 45 that serves as a switching unit between positive pressure and negative pressure. The suction device 51 has a function to separate the medicine package 2 using the pressurized air generated by the negative-pressure generator 45 when the medicine package 2 is to be separated.

As illustrated in FIG. 9A, the suction device 51 as described above sucks up one of the multiple medicine packages 2 as the negative-pressure generator 45 transforms the positive pressure generated by an air compressor 46 that serves as an air compressing means into negative pressure through an air tank 47. The air compressor 46 is installed outside the conveyor 90, and is coupled to the suction device 51 through the air tank 47 and the negative-pressure generator 45 by a member for communication such as an air tube 49. In the air tube 49 between the negative-pressure generator 45 and the suction device 51, a pressure sensor that measures the negative pressure is arranged to determine that the suction device 51 has sucked up one of the multiple medicine packages 2 when the negative pressure measured by a pressure sensor that measures the negative pressure becomes equal to or less than a predetermined value.

The air tube 49 according to the present comparative example is arranged together with, for example, a CABLEVEYOR and a wire harness so as not to be stretched even when the carriage 50 moves inside the medicine dispensing apparatus 200. In other words, as illustrated in FIG. 1A and FIG. 1B, the air tube 49 according to the present comparative example has a one-turn path for each one of the X-axis, the Y-axis, and the Z-axis. Firstly, the air tube 49 is extended from the negative-pressure generator 45 in the Z-axis direction, and makes one turn. Secondly, the air tube 49 is extended in the X-axis direction, and makes one turn. Finally, the air tube 49 is extended in the Y-axis direction and makes one turn, and is coupled to the suction device 51.

The suction device 51 includes a pair of suction pads 52 that suck one of the multiple medicine packages 2, and a suction duct 53 coupled to the pair of suction pads 52. The negative-pressure generator 45 is also called a vacuum ejector valve and communicates with the suction duct 53 through the air tube 49. The suction pad 52 serves as an air suction unit or a suction member that sucks up and picks up one of the multiple medicine packages 2 in one of the multiple cartridges 10. As described above, the upper ends of the pair of suction pads 52 as illustrated in FIG. 9A is arranged to absorb one of the multiple medicine packages 2. The bottom ends of the pair of suction pads 52 as illustrated in FIG. 9A is attached and fixed to the upper end of the suction duct 53 as illustrated in FIG. 9A. The bottom end of the suction duct 53 as illustrated in FIG. 9A is attached and fixed to the suction-pad supporting member 54. A pair of suction pads 52 and suction ducts 53 are arranged in the Y-axis direction.

The carriage 50 is provided with a posture changing unit used to change the posture of one of the multiple medicine packages 2 picked up from one of the multiple cartridges 10 to a substantially vertical posture. The posture changing unit in the carriage 50 includes, for example, a suction-pad supporting member 54 coupled to a suction device base 57 through a rotary shaft 55, a guide unit 59 formed with a guide groove 59a having a specific shape, a guide axis 56 that is fitted into the guide groove 59a of the guide unit 59 to guide the suction-pad supporting member 54, and a suction-device lifting and lowering unit.

The suction-pad supporting member 54 is coupled to the suction device base 57 through the rotary shaft 55. The suction-pad supporting member 54 may be may rotatably or pivotably be arranged around the rotary shaft 55 fixed to the suction-pad supporting member 54 within a range of a predetermined angle. Alternatively, the suction-pad supporting member 54 may be may rotatably or pivotably be arranged around the rotary shaft 55 fixed to the suction device base 57. In other words, in FIG. 9A and FIG. 9B, the distance between the center of the rotary shaft 55 and the center of a guide rod 58 in the X-axis direction is kept constant at all times when the suction device base 57 moves along the guide rod 58 in the up and down directions parallel to the Z-axis direction. The guide rod 58 will be described later in detail.

The suction-device lifting and lowering unit includes a pair of guide rods 58 that are arranged in the Y-axis direction, an endless belt 62 looped around a driving pulley 60 and a driven pulley 61, and a drive motor 63 coupled to the driving pulley 60 through a driving power conveyor such as a gear or a belt. The pair of guide rods 58 guide the suction device base 57 in the Z-axis direction. The drive motor 63 is an example of a driver circuit or driving source of the suction-device lifting and lowering unit.

The suction device base 57 is coupled and fixed to the endless belt 62 at a belt grip 62a fixed to the right end of the suction device base 57. The pair of guide rods 58 are arranged at two different positions in the Y-axis direction, and extend in the Z-axis direction. The bottom ends of those guide rods 58 are fixed to the base frame 50b of the picking-up frame 50a provided for the carriage 50. A pair of guiding holes 57a into which the pair of guide rods 58 are inserted are formed around a right end of the suction device base 57. The pulley axis of each one of the driving pulley 60 and the driven pulley 61 is rotatably supported by an immovable member on the picking-up frame 50a. The drive motor 63 is fixed to an immovable member provided for the picking-up frame 50a of the carriage 50.

When the suction device base 57 is lifted or lowered by the operation of the drive motor 63, the suction device base 57 is moved along the pair of guide rods 58 in the Z-axis direction. Accordingly, the posture of the suction device base 57 on the XY plane can be kept constant in a substantially horizontal state. The suction unit lifting and lowering unit is not limited to the above-described up-and-down reciprocating mechanism driven by a belt. Alternatively, for example, the suction unit lifting and lowering unit may have a reciprocating linear motion mechanism using a rack and pinion.

A pair of guide units 59 are arranged on both sides of the suction device 51 in the Y-axis direction across the suction-pad supporting member 54, and the bottom end of the guide unit 59 is fixed to the base frame 50b. The guide axis 56 is arranged so as to protrude from both ends of the suction-pad supporting member 54 in the Y-axis direction, and is consistently fitted into the guide groove 59a of the guide unit 59 to guide the suction-pad supporting member 54. As illustrated in FIG. 9A, the guide axis 56 is provided below the rotary shaft 55 of the suction-pad supporting member 54 in the Z-axis direction with a certain distance from the rotary shaft 55.

When the suction device base 57 is moved in the Z-axis direction by the operation of the drive motor 63, the guide axis 56 of the suction-pad supporting member 54 is moved in the Z-axis direction parallel to the guide groove 59a having a specific shape while maintaining the posture of the suction device base 57 on the XY plane constant in a substantially horizontal state. Due to such a configuration, the posture of the suction pad 52 can be rotated by approximately 90 degrees. In FIG. 9A, the suction device 51 that is rotated by approximately 90 degrees is indicated by thick broken lines. In the present embodiment, the expression “substantially horizontal state” indicates that the posture of a particular element is within a specific range of tolerance for angle with respect to the horizontal in addition to a state in which the position of a particular element is horizontal.

The guide groove 59a having a specific shape includes the first guide groove portion that extends in the Z-axis direction with relatively great length so as to hold the posture of the pair of suction pads 52 upward as indicated by solid lines in FIG. 9A through the suction-pad supporting member 54 in a substantially horizontal state as guided by the guide axis 56, and the second guide groove that gently draw an obtuse and shallow arc to the right side as it goes downward to rotate the posture of the suction-pad supporting member 54 and the pair of suction pads 52 by approximately 90 degrees. The first guide groove portion and the second guide groove communicate with each other and are coupled to each other.

As illustrated in FIG. 9A and FIG. 9B, the carriage 50 is provided with an upper QR code reader 66 that reads the QR code 6c displayed on, for example, the medicine package 2 stored in one of the multiple cartridges 10. The upper QR code reader 66 has an upper reader unit 66a that reads the QR code 6c at an upper portion thereof, and also serves as a medication-related information reader unit 65.

The upper QR code reader 66 is attached to a side of the carriage 50. The upper QR code reader 66 is also used to read the QR code 6c displayed on the label (see FIG. 6A and FIG. 6B) pasted to the left support portion 13 of the pack pickup slot 17 in one of the multiple cartridges 10. For example, the QR code 6c is read by the upper reader unit 66a of the upper QR code reader 66 immediately before the medicine package 2 is picked up from one of the multiple cartridges 10 by the carriage 50. As illustrated in FIG. 9A and FIG. 9B, the carriage 50 is provided with the lower QR code reader 67 that reads the QR CODE of the label 7 with QR code 6c that is pasted onto the subdivision box 34 described above with reference to FIG. 4A and FIG. 4B. The lower QR code reader 67 has a lower reader unit 67a which also functions as the medication-related information reader unit 65 in the lower portion, and is attached to the side surface of the carriage 50 below the upper QR code reader 66. For example, the QR code 6c on the subdivision box 34 is read by the lower reader unit 67a of the lower QR code reader 67 immediately before the medicine package 2 is picked up from one of the multiple cartridges 10 and is dispensed to desired one of the multiple subdivision boxes 34 of the medicine dispensing tray 30.

The operation of the carriage 50 will be described below. For the sake of explanatory convenience, it is assumed in the present embodiment that by the operation of the conveyor 90 illustrated in FIG. 1A and FIG. 1B, the carriage 50 is arranged below the cartridge tray 20 held by the upper one of the pair of drawers 80 arranged at an uppermost portion and a lower portion of the housing 199 illustrated in FIG. 1A and FIG. 1B. In the present embodiment, it is assumed that the cartridges illustrated in FIG. 5A and FIG. 5B and the multiple cartridge trays illustrated in, for example, FIG. 1A and FIG. 1B are used as the multiple cartridges 10 and the multiple cartridge trays 20, respectively.

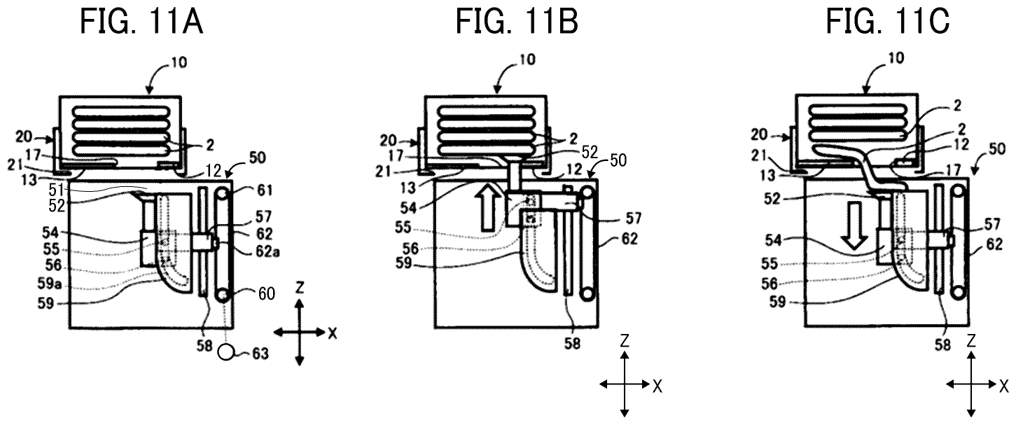

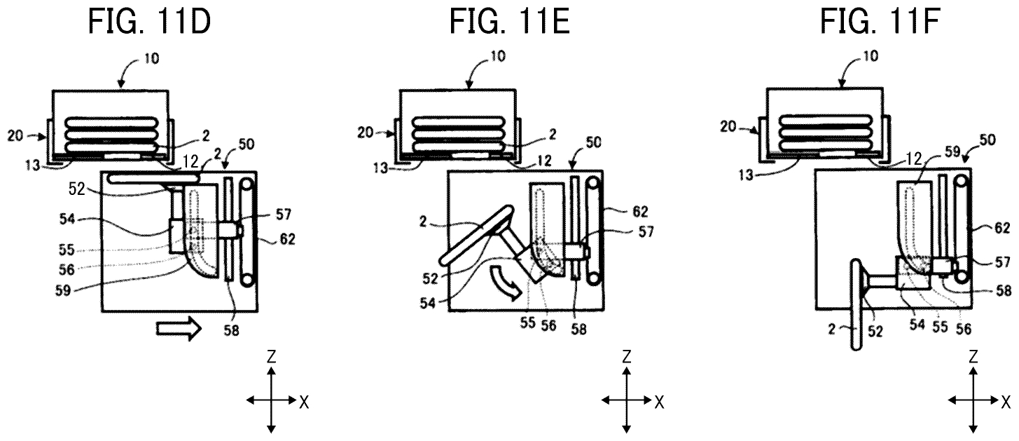

As illustrated in FIG. 10, the carriage 50 can be moved by the conveyor 90 as illustrated in FIG. 1A and FIG. 1B in the X-axis direction and the Y-axis direction in the lower region of one of the multiple cartridges 10 and the cartridge tray 20. Firstly, as illustrated in FIG. 10, the carriage 50 moves to a position under the cartridge tray 20 that holds the cartridges 10 containing the medicine packages 2 to be picked up. In other words, the carriage 50 moves to a position where the upper reader unit 66a of the upper QR code reader 66 on the carriage 50 is approximately directly below the cartridge tray 20 and one of the multiple cartridges 10, and the QR code 6c on the medicine package 2 stored at the bottom of one of the multiple cartridges 10 can be scanned and read by the upper reader unit 66a of the upper QR code reader 66 through a scanning range 9 within the rectangular through opening 21 of the cartridge tray 20. The carriage 50 that is positioned as above reads the QR code 6c displayed on the medicine package 2, using the upper reader unit 66a of the upper QR code reader 66. Subsequently, the carriage 50 is slightly moved by the conveyor 90 as illustrated in FIG. 1A and FIG. 1B from the position as illustrated in FIG. 10 to the right in the X-axis direction as illustrated in the 11A. As a result, the carriage 50 moves to a position where one of the multiple medicine packages 2 at the bottom can be picked up from the same cartridge 10. Under such conditions, the pair of suction pads 52 are positioned under the position of the top face of the pickup device, which indicates the position of the top face of the picking-up frame 50a of the carriage 50. Subsequently, as illustrated in FIG. 11B, the pair of suction pads 52 are moved upward by the operation of the drive motor 63, and enters from the pack pickup slot 17 between the right support portion 12 and the left support portion 13. Then, as soon as the pair of suction pads 52 contact one of the multiple medicine packages 2 at the bottom of one of the multiple cartridges 10, and the pair of suction pads 52 suck that medicine package 2. At that time, the negative-pressure generator 45 has been driven in advance so as to generate a negative pressure, and can suck up the medicine package 2.

Subsequently, as illustrated in FIG. 11C, as the drive motor 63 is reversely operated, the pair of suction pads 52 move downward while sucking one of the multiple medicine packages 2 by the pair of suction pads 52, and the front end of one of the multiple medicine packages 2 is pulled out from one of the multiple cartridges 10. The front end of the medicine package indicates a side of the medicine package to be absorbed or sucked up by the pair of suction pads 52, and the same applies in the following description.

Subsequently, as illustrated in FIG. 11D, by the operation of the conveyor 90, the carriage 50 is moved in the X-axis direction, which is the lateral direction, and the rear end of one of the multiple medicine packages 2 is drawn out or picked up from one of the multiple cartridges 10. Immediately after that, as illustrated in FIG. 11E and FIG. 11F, by the operation of the drive motor 63, one of the multiple medicine packages 2, which is approximately in a horizontal state and is sucked and held by the pair of suction pads 52, is rotated by substantially 90 degrees to change the posture to an approximately vertical or upright posture. In such rotational operation, the guide axis 56 that is arranged on the suction-pad supporting member 54 moves along the guide groove 59a of the guide unit 59. Accordingly, the posture of one of the multiple medicine packages 2 can be changed from an approximately horizontal posture to an approximately vertical posture. The above series of operation in the above configuration may be achieved by a series of operations performed by a single drive motor 63.

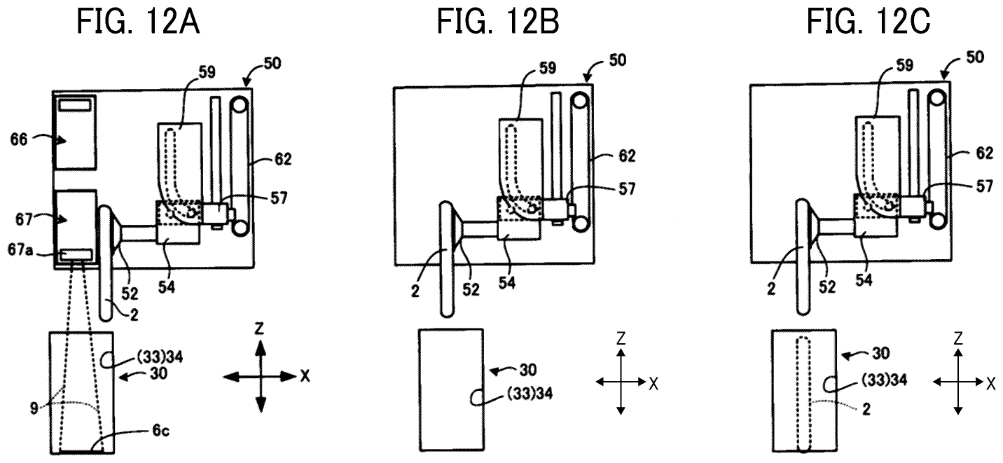

Then, as illustrated in FIG. 12A, the carriage 50 that includes the pair of suction pads 52 and holds one of the multiple medicine packages 2 in a substantially vertical posture is carried by the conveyor 90 to a predetermined position. Accordingly, the lower reader unit 67a of the lower QR code reader 67 in the carriage 50 comes to the predetermined position at which the QR code 6c is displayed at the bottom of predetermined one of the multiple subdivision boxes 34 or rooms 33 of one of the multiple medicine dispensing trays 30 moves to the scanning range 9, and the lower reader unit 67a reads the QR code 6c.

Subsequently, the carriage 50 is slightly moved by the conveyor 90 as illustrated in FIG. 1A and FIG. 1B from the position as illustrated in FIG. 12A to the right in the X-axis direction as illustrated in the 12B. As a result, the carriage 50 moves to a position where the picked-up medicine package 2 can be insertable into to a predetermined one of the multiple subdivision boxes 34 or rooms 33 of the same medicine dispensing tray 30. Then, the carriage 50 stops moving. Once the carriage 50 is carried to a position substantially directly above a predetermined one of the multiple subdivision boxes 34 or rooms 33 of one of the multiple medicine dispensing trays 30 into which the picked-up medicine package 2 is insertable, the negative-pressure generator 45 is driven only for a short time in order to generate a positive pressure from the negative pressure. Accordingly, the pressurized air is blown from the pair of suction pads 52 to the medicine package 2. As a result, the suction holding of one of the multiple medicine packages 2 by the pair of suction pads 52 is released, and one of the multiple medicine packages 2 is inserted into a desired one of the multiple subdivision boxes 34 or a desired one of the multiple rooms 33 of the multiple medicine dispensing trays 30 (see, for example, FIG. 12C).

After the above-described operation is performed a plurality of times and a desired one of the multiple medicine packages 2 is inserted into one of the multiple rooms 33 that is at a predetermined position of one of the multiple medicine dispensing trays 30, one of the multiple medicine dispensing trays 30 is ejected to the outside of the medication support apparatus 300 through the third gate 43 (see FIG. 1A and FIG. 1B), and is received by a staff or the like in a day-care center or nursing home or a medication assistant.

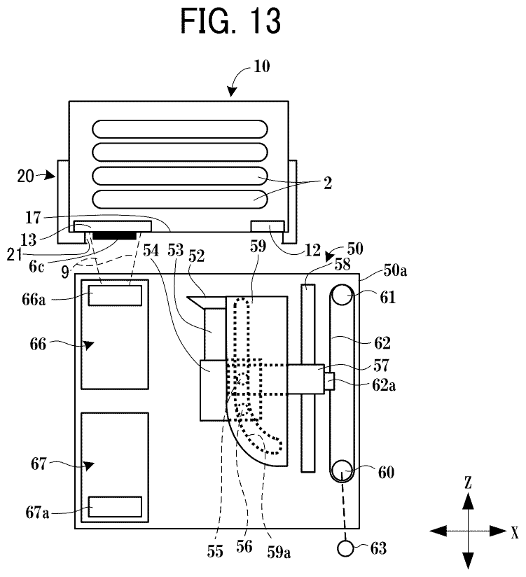

When the QR code 6c that is displayed on one of the multiple cartridges 10, as illustrated in FIG. 6A and FIG. 6B, is read by the upper reader unit 66a of the upper QR code reader 66 of FIG. 9A and FIG. 9B, as illustrated in FIG. 13, the QR code 6c that is displayed on the bottom wall of the left support portion 13 of one of the multiple cartridges 10 is read. More specifically, the carriage 50 is moved to a left position in the X-axis direction within the scanning range 9 in which the QR code 6c displayed on the bottom wall of the left support portion 13 of one of the multiple cartridges 10 can be scanned and read by the upper reader unit 66a of the upper QR code reader 66 in the carriage 50. The other operations of the carriage 50 are equivalent to the operations described above with reference to FIG. 11A to FIG. 12B.

As described above, in the present embodiment, when desired one of the multiple medicine packages 2 is picked up from one of the multiple cartridges 10, the carriage 50 is positioned under one of the multiple cartridges 10 and one of the multiple cartridge trays 20, and such desired one of the multiple medicine packages 2 is taken out in the downward direction of one of the multiple cartridges 10. When one of the multiple medicine packages 2 is taken out from the lower side of one of the multiple cartridges 10 as described above, the next one of the multiple medicine packages 2 automatically moves downward or toward the pack pickup slot 17 due to the self weight of the movable board 16 and the multiple medicine packages 2 left in one of the multiple cartridges 10. Due to such a configuration, the carriage 50 can perform the same operation with a relatively simple configuration regardless of the number of the multiple medicine packages 2 left in one of the multiple cartridges 10.

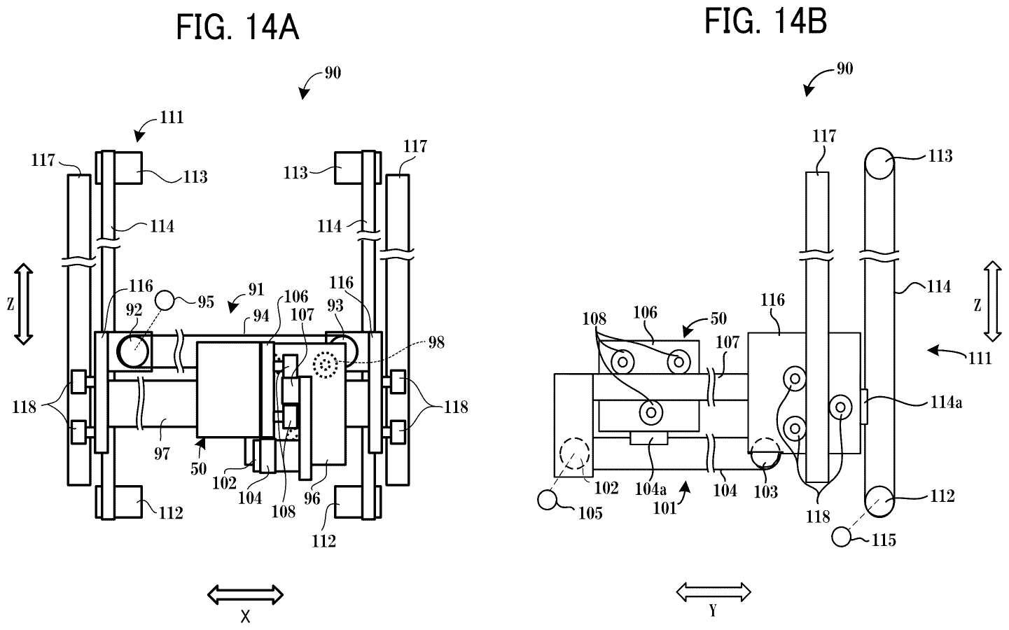

FIG. 14A is a front view of the conveyor 90 illustrating a schematic configuration of the conveyor 90.

FIG. 14B is a side view of the conveyor 90 illustrated in FIG. 14A.

As in the configuration or structure of the medicine dispensing apparatus 200 illustrated in FIG. 1A and FIG. 1B, the multiple cartridges 10 are aligned in a row on a plane under the medicine dispensing tray 30 in the Z-axis direction, and the medicine dispensing tray 30 is arranged at an uppermost portion of the housing 199 and further above the upper portions of the multiple cartridges 10. In view of these circumstances, the carriage 50 is configured to move in three directions of the X-axis direction, the Y-axis direction, and the Z-axis direction. As described above, the conveyor 90 moves the carriage 50 in the X-axis direction, the Y-axis direction, and the Z-axis direction in order to convey one of the multiple medicine packages 2 picked up from one of the multiple cartridges 10 by the carriage 50 and pass it to one of the multiple medicine dispensing trays 30.

The carriage 50 is moved in the X-axis direction by an X-axis direction conveyor 91, and the carriage 50 is moved in the Y-axis direction by a Y-axis direction conveyor 101. The carriage 50 is moved in the Z-axis direction by a Z-axis direction conveyor 111. These three conveyors have a similar configuration or structure.

The X-axis direction conveyor 91 includes an X-adaptor 96 attached to the carriage 50, an X-guide unit 97 that guides the carriage 50 in the X-axis direction through the X-adaptor 96, an endless belt 94 looped around a driving pulley 92 and a driven pulley 93, and a drive motor 95 used for the conveyance in the X-axis direction. The drive motor 95 is coupled to the driving pulley 92 through a driving force conveyor such as a gear or a belt. As illustrated in FIG. 14B, three rollers 98 are attached to the X-adaptor 96 so as to clamp the X-guide unit 97. Due to such a configuration, the X-adaptor 96 can roll over the X-guide unit 97. Note that, in FIG. 14B, two of the three rollers 98 are hidden by the carriage 50. The X-adaptor 96 is fixedly coupled to the endless belt 94 through a belt grip.

With the above-described configuration of the X-axis direction conveyor 91, as the drive motor 95 is driven, the driving force is conveyed to the endless belt 94 through the driving force conveyor and the driving pulley 92. Accordingly, the endless belt 94 rotates, and the carriage 50 moves in the X-axis direction parallel to the X-guide unit 97 together with the X-adaptor 96.

The Y-axis direction conveyor 101 includes a Y-adaptor 106 attached to the carriage 50, a Y-guide unit 107 that guides the carriage 50 in the Y-axis direction through the Y-adaptor 106, an endless belt 104 looped around a driving pulley 102 and a driven pulley 103, and a drive motor 105 used for the conveyance in the Y-axis direction. The drive motor 105 is coupled to the driving pulley 102 through a driving force conveyor such as a gear or a belt. Three rollers 108 are attached to the Y-adaptor 106 so as to clamp the Y-guide unit 107. Due to such a configuration, the Y-adaptor 106 can roll over the Y-guide unit 107. The Y-adaptor 106 is coupled and fixed to the endless belt 104 through the belt grip 104a.

With the above-described configuration of the Y-axis direction conveyor 101, as the drive motor 105 is driven, the driving force is conveyed to the endless belt 104 through the driving force conveyor and the driving pulley 102. Accordingly, the endless belt 104 rotates, and the carriage 50 moves in the Y-axis direction parallel to the Y-guide unit 107 together with the Y-adaptor 106.

The Z-axis direction conveyor 111 includes a pair of Z-adaptors 116 attached to both ends of the X-guide unit 97 in the X-axis direction, a pair of Z-guide units 117 that guides the carriage 50 in the Z-axis direction through the X-guide unit 97 and the pair of Z-adaptors 116, an endless belt 114 looped around a driving pulley 112 and a driven pulley 113, and a drive motor 115 used for the conveyance in the Z-axis direction. The drive motor 115 is coupled to the driving pulley 112 through a driving force conveyor such as a gear or a belt. In the Z-axis direction conveyor 111, the pair of driving pulleys 112, the pair of driven pulleys 113, and the pair of endless belts 114 are arranged on both sides in the X-axis direction, respectively. By contrast, the drive motor 115 is provided for only on one of the pair of driving pulleys 112. three rollers 118 are attached to each one of the pair of Z-adaptors 116 so as to clamp corresponding one of the pair of Z-guide units 117. Due to such a configuration, the pair of Z-adaptors 116 can roll over the pair of Z-guide units 117, respectively. The pair of Z-adaptors 116 are coupled and fixed to the pair of endless belts 114 through a pair of belt grips 114a, respectively.

With the above-described configuration of the Z-axis direction conveyor 111, as the drive motor 115 is driven, the driving force is conveyed to the pair of endless belts 114 through the driving force conveyor and the driving pulley 112. Accordingly, the pair of endless belts 114 rotates, and the carriage 50 moves in the Z-axis direction parallel to the Z-guide unit 117 together with the X-guide unit 97 and the Z-adaptor 116.

In FIG. 14A and FIG. 14B, the carriage 50 is configured to move in the triaxial directions including the X-axis direction, the Y-axis direction, and the Z-axis direction. However, no limitation is indicated thereby. For example, when the multiple cartridges 10 are arranged above the carriage 50 and the multiple medicine dispensing trays 30 are arranged below the carriage 50, the carriage 50 only needs to move in the X-axis direction and the Y-axis direction. In such cases, the number of axes of motion can be reduced by one.

In the present embodiment, the QR code reader is divided into two sections including the upper QR code reader 66 provided with the upper reader unit 66a and the lower QR code reader 67 provided with the lower reader unit 67a. However, no limitation is indicated thereby, and one integrated QR code reader may be used.

As will be described later, the reading operation of the QR code 6c is controlled to automatically start upon detecting the storing of one of or both one of the multiple cartridges 10 and one of the multiple medicine dispensing trays 30. The reading operation of the QR code 6c may start immediately before one medicine pack is picked up from one of the multiple cartridges 10 or immediately before medicines are dispensed to one of the multiple medicine dispensing trays 30. Alternatively, the reading operation of the QR code 6c may start at any time specified by an operation made by a user. No limitation is intended thereby in terms of a method for implementation. In the present embodiment, the QR code 6c on the carriage 50 and the QR code 6c on each one of the multiple subdivision boxes 34 of the medicine dispensing tray 30 are read, and multiple items of information are stored. Then, such multiple items of information are used to make comparison when medicines are dispensed.

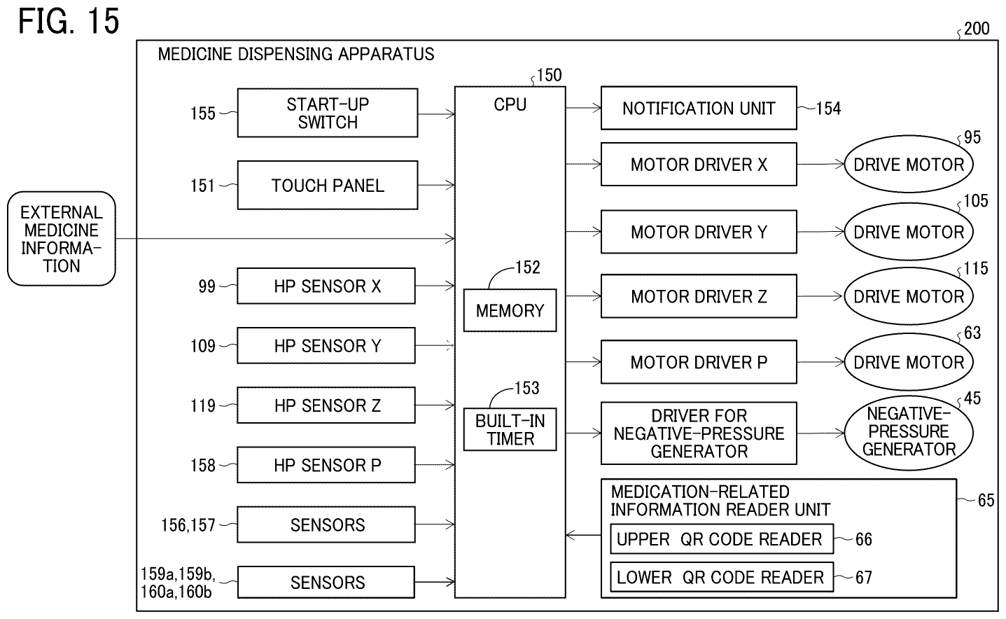

FIG. 15 is a diagram illustrating the control blocks of the medicine dispensing apparatus 200.

As illustrated in FIG. 15, the medicine dispensing apparatus 200 includes a central processing unit (CPU) that serves as a controller 150 that controls the operation of, for example, the components or elements of the medicine dispensing apparatus 200. For example, the CPU may be provided with a built-in memory or a built-in timer. The CPU according to the present embodiment may provide notification to a staff or the like at a timing consistent with the program or may instruct the medicine dispensing apparatus 200 to perform particular operation, based on various kinds of input such as the inputs from a sensor as will be described later in detail.

The CPU may have, for example, a computing or control function, and a timer or clocking function. The memory 152 of the controller 150 includes a random-access memory (RAM) that is referred to as a main memory, and a read-only memory (ROM). The ROM according to the present embodiment stores, for example, a program readable by the above CPU and various kinds of data in advance. Such a program stored in the ROM may be a program used in the flowchart of the controlling processes as will be described later in detail. The above various kinds of data may be, for example, the data about the relation between the multiple medicine packages 2 and the multiple rooms 33 or the multiple subdivision boxes 34 of one of the multiple medicine dispensing trays 30 allocated to each of the patients who take medicines, the data about the relation between the multiple medicine packages 2 and the multiple rooms 33 or the multiple subdivision boxes 34 of one of the multiple medicine dispensing trays 30 assigned to each one of the times of medication, or the data about the relation between the multiple medicine packages 2 and the multiple rooms 33 or the multiple subdivision boxes 34 of one of the multiple medicine dispensing trays 30 sorted according to the order in which medicines are to be taken.

The CPU has an input and output (I/O) port, and a touch panel 151 that serves as a user interface (UI) is electrically connected to that input and output port of the CPU. However, the user interface (UI) is not limited to the touch panel 151, and may be, for example, a combination of an input device and a display interface such as a combination of a keyboard and a light-emitting diode (LED) display.

The CPU has an input port, and a medicine dispensing tray sensor 156 that detects the type of medicine dispensing tray 30 stored in the medicine dispensing apparatus 200 or determines whether or not there is any medicine dispensing tray 30, and a cartridge sensor 157 that determines whether or not there is any one of the multiple cartridges 10 are electrically connected to the input port of the CPU. As various types of sensors, a pair of drawer gate opening and closing sensors 159a and 159b that detect the opening and closing of the first gate 41 and the second gate 42 and a pair of medicine dispensing tray gate opening and closing sensors 160a and 160b that detect the opening and closing of the third gate 43 and the fourth gate 44 are electrically connected to the input port of the CPU. The medicine dispensing tray sensor 156, the cartridge sensor 157, the pair of drawer gate opening and closing sensor 159a and 159b, and the pair of medicine dispensing tray gate opening and closing sensors 160a and 160b are illustrated in FIG. 15.

Moreover, a HP sensor 99 for a HP sensor X, which detects the home position (HP) of the X-axis direction conveyor 91 in the carriage 50, a HP sensor 109 for a HP sensor Y, which detects the home position (HP) of the Y-axis direction conveyor 101 in the carriage 50, and a HP sensor 119 for a HP sensor Z, which detects the home position (HP) of the Z-axis direction conveyor 111 in the carriage 50 are electrically connected to the input port of the CPU. Note that such a home position (HP) of each conveyance unit may be abbreviated to HP in the following description. Further, to the input port of the CPU, a home position (HP) sensor 158 for a HP sensor P, which detects the home positions (HP) of the pair of suction pads 52 of the suction device 51 in the carriage 50 is electrically connected.

The upper reader unit 66a and the lower reader unit 67a of the upper QR code reader 66, each of which is an example of the medication-related information reader unit 65 and is arranged on the carriage 50, are electrically connected to the input port of the CPU.

To the output port of the above CPU, the drive motor 95 for the X-axis direction conveyor 91, the drive motor 105 for the Y-axis direction conveyor 101, the drive motor 115 for the Z-axis direction conveyor 111, and the drive motor 63 used to change the posture or attitude of the pair of suction pads 52 are electrically connected to the input port of the CPU through various kinds of motor drivers X, Y, Z, and P, respectively. Moreover, to the output port of the above CPU, the negative-pressure generator 45 that is an example as an ejector valve and an actuator used for the negative pressure generator is electrically connected through a driver used for a negative-pressure generator.

To the output port of the CPU, a notification unit may be electrically connected. The notification unit reports what sort of state or conditions the components or elements of the medicine dispensing apparatus 200 are in by means of, for example, the light emitted from a light-emitting diode (LED) and the sound or vibration including voice. Moreover, the notification unit may be provided with, for example, a loudspeaker or a light that indicates that the medicines are to be taken so that the staff or the like away from the medicine dispensing apparatus 200 can be notified of such a time of medication.

The external medicine information is also input to the CPU through an input and output (I/O) interface, and is stored in the built-in memory 152. For example, the external medicine information is used for the allocation of medicines to patients who take medicines. For example, the LEDs 25al to 25d5 of the drawer 80 may be electrically connected to each other.

Once the input data from the touch panel 151 and various kinds of signals from various types of sensors or the HP sensors 99, 109, 119, and 158 are input to the CPU, a command signal is newly output from the CPU. In other words, the CPU according to the present embodiment outputs a command signal used to control the audio device or the optical device of the display device of the touch panel 151 including the above notification unit, the LEDs 25al to 25d5, the negative-pressure generator 45, the drive motor 63, the drive motor 95, the drive motor 105, the drive motor 115, or the multiple drives that correspond to the multiple LEDs.

The HP sensor 158 for the HP sensor P and the drive motor 63 that is driven through the motor driver P are used to control or drive the mechanism for moving the suction device to move upward and downward. The CPU according to the present embodiment has a function to execute various kinds of control operation as will be described later in detail in the following description or the flowchart of the controlling processes.

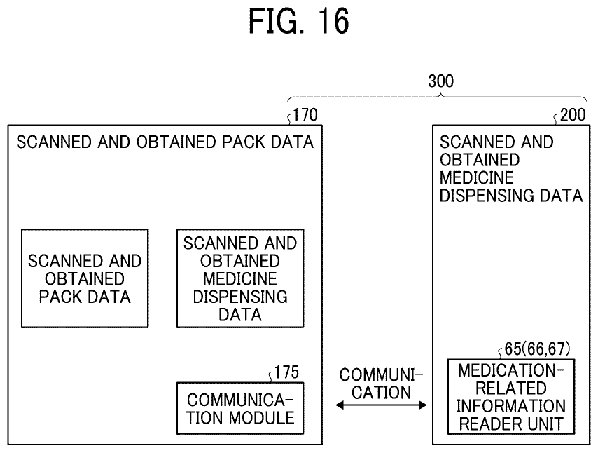

FIG. 16 is a diagram illustrating the control blocks of the medicine dispensing apparatus 200.

As illustrated in FIG. 16, the medication support apparatus 300 is provided with the above-described medicine dispensing apparatus 200 and a memory 170 coupled to the medicine dispensing apparatus 200. Such coupling enables communication such as data transmission and data reception. The memory 170 serves as an external storage device provided for the medicine dispensing apparatus 200 with relatively large storage capacity compared with the main memory whose storage capacity is relatively small, and may be a server or a personal computer (PC) that can exchange data through the network communication. The memory 170 may be integrally formed inside the medicine dispensing apparatus 200 to make up the medication support apparatus 300.

The memory 170 stores the scanned and obtained pack data and the scanned and obtained medicine dispensing data, each of which is an example of the medication-related information and corresponds to the QR code 6c that is arranged on at least one of the multiple cartridges, the multiple medicine packs, and the multiple medicine dispensing trays, and is scanned and obtained by the upper QR code reader 66 or the lower QR code reader 67 of the medication-related information reader unit 65 provided for the medicine dispensing apparatus 200 to serve as a pack data reader. The memory 170 exchanges the above scanned and obtained pack data stored therein and the above scanned and obtained medicine-dispensing data stored therein with the medicine dispensing apparatus 200.

In the present embodiment, some supplementary explanation of the reading operation of the QR code 6c is given below. When the QR code 6c is indicated on the surface of the medicine pack as illustrated FIG. 5B, the QR code 6c is visible through the pack pickup slot 17 as illustrated in FIG. 10, and the QR code is read by the upper reader unit 66a of the upper QR code reader 66. Even when the QR code 6c is displayed on the left support portion 13 on the bottom wall of one of the multiple cartridges 10 as illustrated in FIG. 6A and FIG. 6B, the QR code 6c can be read by the upper reader unit 66a of the upper QR code reader 66 in a similar manner to the above because, as illustrated in FIG. 13, the position at which the QR code 6c is displayed is the pack pickup slot 17. As illustrated in FIG. 12A, also when the carriage 50 moves to a position above desired one of the multiple subdivision boxes 34 of the medicine dispensing tray 30 while holding one of the multiple medicine packages 2 picked up from one of the multiple cartridges 10, the QR code 6c can be read by the lower reader unit 67a of the lower QR code reader 67 in a similar manner to the above. As a result, the medication-related information that is read by the upper QR code reader 66 or the lower QR code reader 67 is sent to the memory 170 through the communication module 175, and stored as the scanned and obtained pack data and the scanned and obtained medicine-dispensing data.

As the carriage 50 is provided with the upper QR code reader 66 and the lower QR code reader 67, the name of a patient who takes medicines and the current position of the cartridge 10 in which the medicine pack to be taken by the patient who takes medicines is stored can be detected by the movement of the carriage 50 in the medicine dispensing apparatus 200. In other words, when the QR CODE on one of the multiple cartridges 10 is read by the upper QR code reader 66 to obtain the position coordinates of the cartridge 10 in the medicine dispensing apparatus 200 corresponding to the current position of the cartridge 10, the position coordinates of the carriage 50 corresponding to the current position of the cartridge 10 can be linked to the QR code 6c. In the position coordinates of the cartridge, for example, X, Y, and Z indicate the rows, columns, and stages, respectively.

The flowchart of an operation in which the QR code 6c is scanned and obtained is described below. Firstly, cases are described in which the reading operation of the QR code 6c by the upper reader unit 66a of the upper QR code reader 66 is described immediately before the medicine package 2 is picked up from one of the multiple cartridges 10 by the carriage 50.

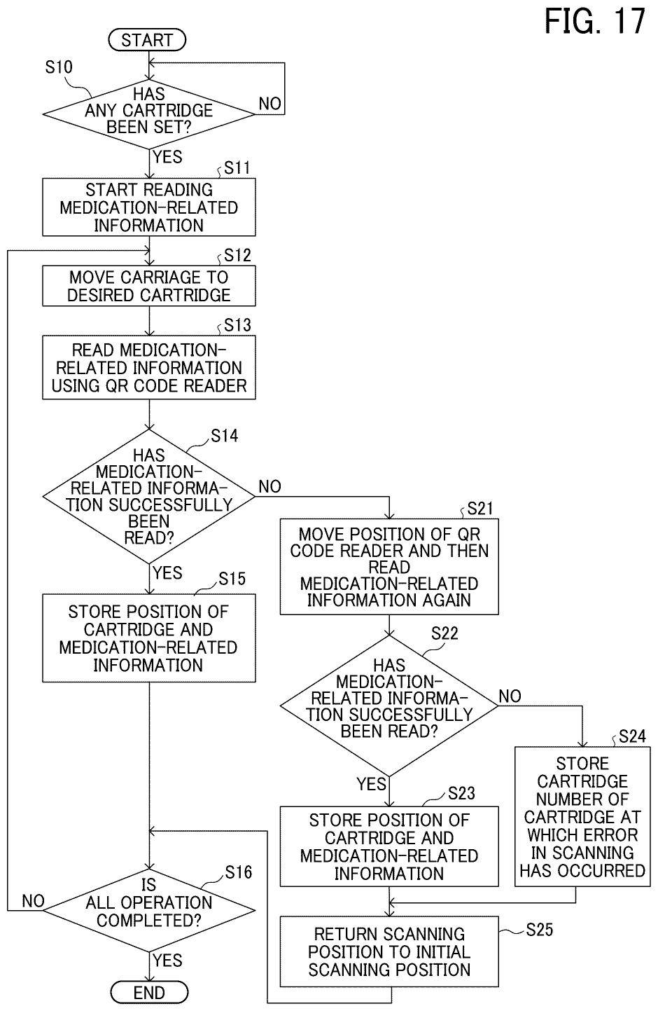

FIG. 17 is a flowchart of the operation of reading the QR code 6c on one of the cartridges 10.

Firstly, in step S10, whether any one of the cartridges 10 has been set is checked. When the desired one of the multiple cartridges 10 is appropriately set, in step S11, the upper QR code reader 66 starts reading the medication-related information. More specifically, for example, a sensor or a switch detects that one of the multiple cartridges 10 is installed at a certain position. For example, the data reading operation automatically starts after it is confirmed that the cover provided for the medication support apparatus 300 is closed and the safety is ensured. The same applies to the equivalent operations given below.

Subsequently, the carriage 50 moves to a desired one of the cartridges 10, and the upper QR code reader 66 reads the medication-related information from the QR code 6c (see the processes in the step S12 and the step S13 described above with reference to FIG. 10). Subsequently, in step S14, whether the medication-related information has successfully been read by the upper QR code reader 66 is checked. If the medication-related information has successfully been read by the QR code reader in the step S14 (YES in step S14), the positions of the cartridges 10 and the medication-related information are stored in step S15. When all the above operation in the step S12 to the step S15 is completed, in step S16, the operation terminates. When the operations in the step S12 to the step S15 are not all complete in the step S16, the process returns to the processes in the step S12, and the same series of processes in the above steps are repeated.

By contrast, in step S14, there are some cases in which the upper QR code reader 66 fails to read the medication-related information. For example, when the QR code 6c is damaged or partly lost due to a smear, the reading operation of the QR code 6c may end in failure. The reflection of illumination may cause blooming whites on the read image of a QR CODE, and the reading operation of the QR code 6c may end in failure. For example, when the damage or loss due to a smear on the QR code 6c is minor and not serious or when the reading operation fails due to the reflection of illumination, the QR code 6c may successfully be read by changing the scanning position of the upper QR code reader 66 for the QR code 6c or the relative positions of the upper QR code reader 66 and the QR code 6c.

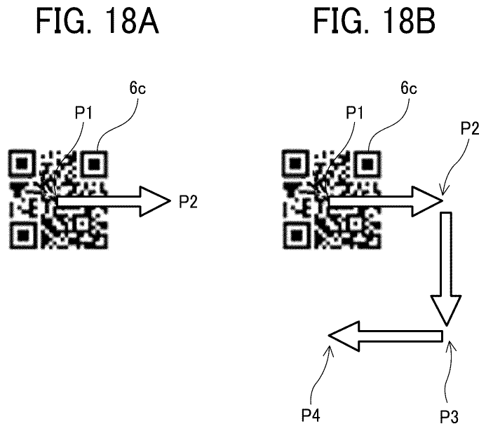

In order to achieve such functions, in the present embodiment, when the upper QR code reader 66 fails to read the medication-related information (NO in step S14), in step S21, a retrying operation in which the position of the upper QR code reader 66 is moved and the medication-related information is read again is performed. Regarding the movement patterns during a retrying operation, as illustrated in, for example, FIG. 18A, the scanning position of the upper QR code reader 66 for the QR code 6c is moved to the right in the X-axis direction from the initial scanning position P1, and is changed to the second scanning position P2. By changing the scanning position in this way, the QR code 6c with a minor damage or loss due to a smear may successfully be read. By changing the scanning position in this way, the relative positions of the upper QR code reader 66 and the illumination change, and how the illumination is reflected changes. Accordingly, the QR code 6c may successfully be read.

Subsequently, in step S21, retrying operation is performed, and in step S22, whether the medication-related information has successfully been read by the upper QR code reader 66 is checked. If the medication-related information has successfully been read by the QR code reader (YES in step S22), the positions of the cartridges 10 and the medication-related information are stored in step S23. Subsequently, in step S25, the scanning position of the upper QR code reader 66 for the QR code 6c is returned from the second scanning position P2 to the initial scanning position P1, and the process return to the processes in the step S12.

By contrast, when the medication-related information has not successfully been read despite the retrying operation (NO in step S22), in step S24, the cartridge number of the cartridge at which error in scanning has occurred is stored. Subsequently, in step S25, the scanning position of the upper QR code reader 66 for the QR code 6c is returned from the second scanning position P2 to the initial scanning position P1, and the process return to the processes in the step S12.

In the present embodiment, in step S25, the scanning position of the upper QR code reader 66 for the QR code 6c is returned to the initial scanning position after the retry operation is performed in step S25. Due to such a configuration, the subsequent control operation can be done in a similar manner regardless of whether the retrying operation is performed or not, and the control becomes easy.

In the present specific embodiment, when the reading operation of the QR code 6c ends in failure, a retrying operation in which the position of the upper QR code reader 66 is moved and the medication-related information is read again is performed only once. However, no limitation is indicated thereby, and the retrying operation may be performed several times. In such cases, it is desired that the retrying operations for the second and following times be performed at positions different from the scanning positions during the retrying operations performed so far.

For example, as described above with reference to FIG. 18B, the scanning position of the upper QR code reader 66 for the QR code 6c is moved to the right in the X-axis direction from the initial scanning position P1 and is changed to the second scanning position P2, and then the retrying operation is performed for the first time. When the medication-related information has not successfully been read in this retrying operation, the scanning position of the upper QR code reader 66 is moved downward in the Y-axis direction from the second scanning position P2 and is changed to the third scanning position P3, and then the retrying operation is performed for the second time. When the medication-related information has not successfully been read in this retrying operation, the scanning position of the upper QR code reader 66 is moved to the left in the X-axis direction from the third scanning position P3 and is changed to the fourth scanning position P4, and then the retrying operation is performed for the third time. When the medication-related information has not successfully been read in the retrying operation for the third time, the cartridge number of the cartridge at which error in scanning has occurred is stored.

In FIG. 18B, the retrying operation is performed three times. However, no limitation is indicated thereby, and the retrying operation may be performed twice or four times or more. In the present embodiment described with reference to FIG. 18B where the retrying operation is performed, before the process returns to the processes in the step S12, it is desired that the scanning position of the upper QR code reader 66 be returned from the scanning positions P2 to P4 after the change to the initial scanning position P1.

In FIG. 18A and FIG. 18B, the upper QR code reader 66 starts the reading operation after the scanning position of the upper QR code reader 66 is changed and the upper QR code reader 66 has moved. However, no limitation is intended thereby. For example, the upper QR code reader 66 may perform the reading operation while the scanning position of the upper QR code reader 66 is being changed or the upper QR code reader 66 is moving. In such cases, the probability of successful scanning of the QR code 6c can be increased.

The reading operation for the QR code 6c using the lower reader unit 67a of the lower QR code reader 67 is described below, which is performed immediately before one of the multiple medicine packages 2 picked up from one of the multiple cartridges 10 is dispensed to one of the multiple subdivision boxes 34 of the medicine dispensing tray 30.

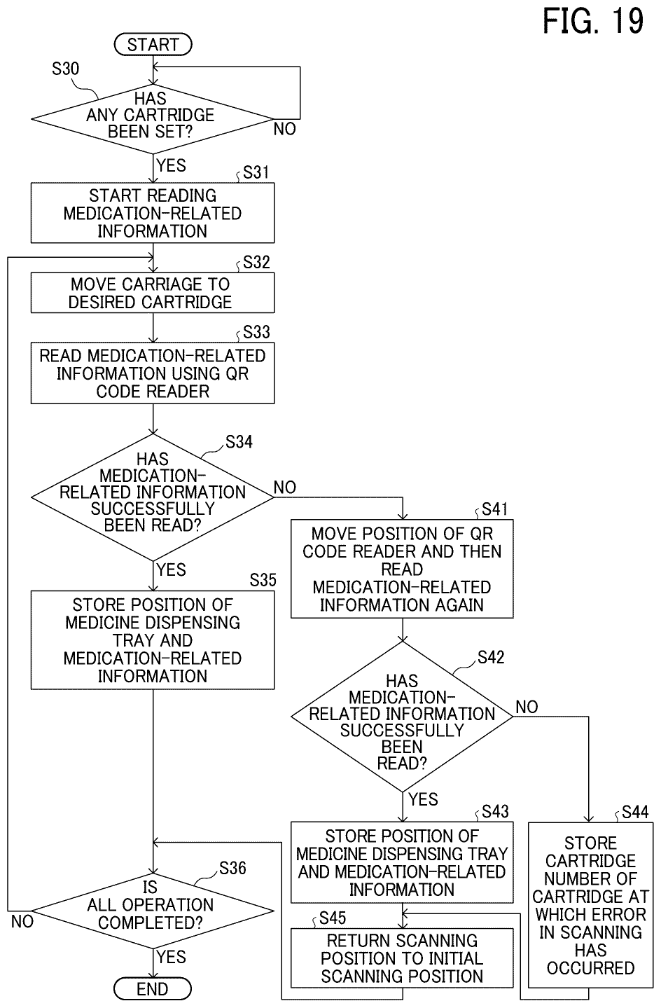

FIG. 19 is a flowchart of the operation of reading the QR code 6c on the medicine dispensing tray 30.

Firstly, in step S30, whether any one of the multiple medicine dispensing trays 30 has been set is checked. If the medicine dispensing tray 30 is appropriately set, in step S31, the lower QR code reader 67 starts reading the medication-related information. More specifically, for example, a sensor or a switch detects that one of the multiple medicine dispensing trays 30 is installed at a certain position. For example, the data reading operation automatically starts after it is confirmed that the cover provided for the medication support apparatus 300 is closed and the safety is ensured.

Subsequently, the carriage 50 moves to a desired one of the multiple medicine dispensing trays 30 in step S32, and the medication-related information is read from the QR code 6c by the lower QR code reader 67 in step S33 (see also FIG. 12A). Subsequently, in step S34, whether the medication-related information has successfully been read by the lower QR code reader 67 is checked. If the lower QR code reader 67 has successfully read the medication-related information in the step S34 (YES in step S34), in step S35, the position of the medicine dispensing tray 30 and the medication-related information are stored. Once all the above operation in the step S32 to the step S35 is completed, the operation terminates in step S36. When the operations in the step S23 to the step S35 are not all complete in the step S36, the process returns to the processes in the step S32, and the same series of processes in the above steps are repeated.

On the other hand, in step S34, the reading operation of the medication-related information by the lower QR code reader 67 may end in failure in a similar manner to the above reading operation of the medication-related information by the upper QR code reader 66.

In order to achieve such functions, in the present embodiment, when the lower QR code reader 67 fails to read the medication-related information (NO in step S34), in step S41, the position of the lower QR code reader 67 is moved and then retrying operation in which the medication-related information is read again is performed. Regarding the movement patterns during a retrying operation, in a similar manner to the example illustrated in FIG. 18A, the scanning position of the lower QR code reader 67 for the QR code 6c is moved to the right in the X-axis direction from the initial scanning position P1, and is changed to the second scanning position P2. By changing the scanning position in this way, the QR code 6c with a minor damage or loss due to a smear may successfully be read. By changing the scanning position in this way, the relative positions of the lower QR code reader 67 and the illumination changes, and how the illumination is reflected changes. Accordingly, the QR code 6c may successfully be read.

Subsequently, in step S41, retrying operation is performed, and in step S42, whether the medication-related information has successfully been read by the lower QR code reader 67 is checked. If the QR code reader has successfully read the medication-related information (YES in step S42), the position of the medicine dispensing tray 30 and the medication-related information are stored in step S43. Subsequently, in step S45, the scanning position of the lower QR code reader 67 for the QR code 6c is returned from the second scanning position P2 after the change to the initial scanning position P1, and in step S32, the process return to the processes.

On the other hand, when the medication-related information has not successfully been read despite the retrying operation (NO in step S42), in step S44, the number of the medicine dispensing tray at which error in scanning has occurred is stored. Subsequently, in step S45, the scanning position of the lower QR code reader 67 for the QR code 6c is returned from the second scanning position P2 after the change to the initial scanning position P1, and in step S32, the process return to the processes. In a similar manner to, for example, the example illustrated in FIG. 18B, a retrying operation in which the position of the upper QR code reader 66 is moved and the medication-related information is read again when the reading operation of the QR code 6c ends in failure may be performed several times. What is done, e.g., movement patterns, in a retrying operation may differ from one another between when the QR code 6c on one of the cartridges 10 is read and when the QR code 6c on the medicine dispensing tray 30 is read.

In the present embodiment, the movement patterns during a retrying operation, which are changes in the relative positions of the QR code reader and the QR code 6c, are made in the X-axis direction and the Y-axis direction approximately parallel to the display surface of the QR code 6c. However, no limitation is intended thereby.

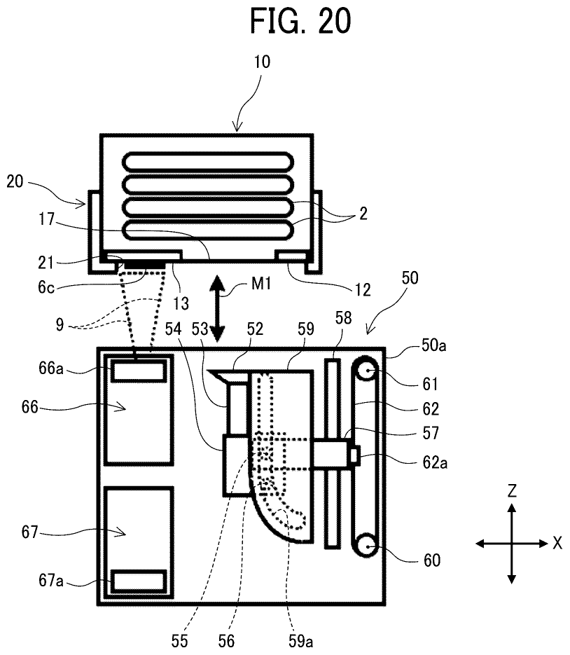

For example, in the movement patterns during a retrying operation, the relative positions of the QR code reader and the QR code 6c may be changed in the Z-axis direction by moving the QR code reader in the Z-axis direction approximately orthogonal to the display surface of the QR code 6c as indicated by reference sign M1 in FIG. 20. In such cases, the focal length or imaging distance between the QR code reader and the QR code 6c changes, and the QR code 6c with a minor damage or loss due to a smear may successfully be read. As the relative positions of the QR code reader and the illumination change, how the illumination is reflected changes, and the QR code 6c may successfully be read.

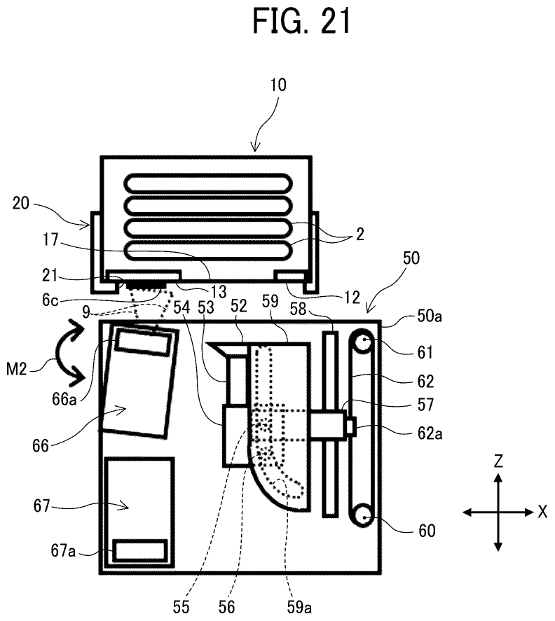

In the movement patterns during a retrying operation, for example, the relative positions of the QR code reader and the QR code 6c may be changed by rotating the QR code reader on the axis in the Y-axis direction as indicated by reference sign M2 in FIG. 21 such that the tilt angle of the QR code 6c with reference to the direction of the normal to the display surface of the QR code 6c changes. In such cases, the focal length or imaging distance between the QR code reader and the QR code 6c changes, and the QR code 6c with a minor damage or loss due to a smear may successfully be read. As the relative positions of the QR code reader and the illumination change, how the illumination is reflected changes, and the QR code 6c may successfully be read. Also in such cases, the relative positions of the QR code reader and the QR code 6c change, and the QR code 6c with a minor damage or loss due to a smear may successfully be read. As the relative positions of the QR code reader and the illumination change, how the illumination is reflected changes, and the QR code 6c may successfully be read.

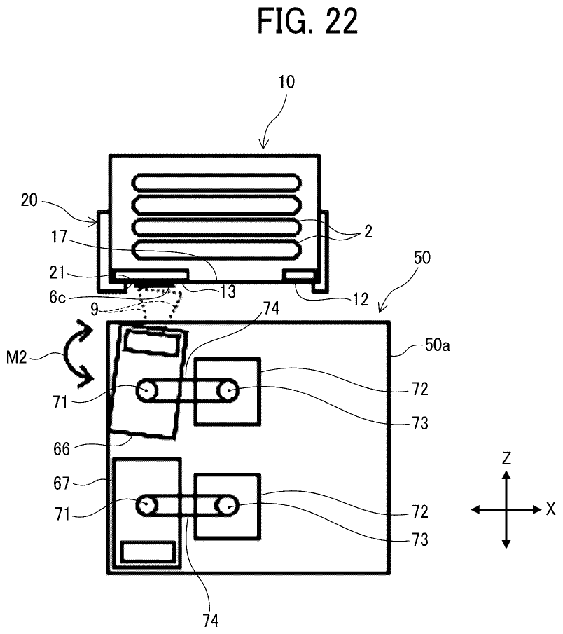

FIG. 22 is a diagram illustrating a configuration or structure with which the QR code reader is rotated on the axis in the Y-axis direction.

In the present embodiment described below with reference to FIG. 22, a driving mechanism that rotates on the axis of the QR code reader in the Y-axis direction includes a driven pulley 71 provided for each one of the upper QR code reader 66 and the lower QR code reader 67, a driving pulley 73 provided for the motor axis of a drive motor 72, and a belt 74 looped around the driven pulley 71 and the driving pulley 73. As the drive motor 72 is driven under the control of the controller 150, the upper QR code reader 66 or the lower QR code reader 67 rotate on its axis in the Y-axis direction through the driving pulley 73, the belt 74, and the driven pulley 71. Accordingly, the relative positions of the QR code 6c and the upper QR code reader 66 or the lower QR code reader 67 are changed such that the tilt angle of the QR code 6c with reference to the direction of the normal to the display surface of the QR code 6c changes.

The driving mechanism that rotates on the axis of the QR code reader in the Y-axis direction is not limited to the example illustrated in FIG. 22. For example, a driving mechanism that uses a solenoid to rotate the QR code reader on the axis in the Y-axis direction may be adopted, or a mechanism for rotating the entirety of the carriage provided with the QR code reader may be adopted.

The embodiments described above are given as an example, and unique advantageous effects are achieved for each of the following modes given below.

### First Mode

A medication support apparatus includes a container such as the cartridge 10 to store a medicine pack such as the medicine packages 2, a conveyor such as the carriage 50 and the conveyor 90 that picks up the medicine pack from the container and conveys the picked-up medicine pack to a medicine placement unit such as the subdivision box 34 in which the medicine pack is to be placed, a data reader such as the upper QR code reader 66 and the lower QR code reader 67 that reads medication-related information such as the name of a patient who takes medicines and the times of medication from the data retaining medium such as the QR code 6c arranged on at least one of the medicine pack, the container, and the medicine placement unit, and the controller 150 that controls a reading operation by the data reader. When the data reader fails to read the medication-related information from the data retaining medium, the controller changes relative positions of the data retaining medium and the data reader, and causes the data reader to read the medication-related information again from the data retaining medium.

The data reader that reads the medication-related information from the data retaining medium disposed on at least one of the medicine placement unit, the container, and the medicine pack may fail to read the medication-related information. In such cases, with the medication support apparatus 300 according to the present aspect, the relative positions of the data retaining medium and the data reader is changed, and the medication-related information is read again from the data retaining medium by the data reader. Due to such a configuration, even if the data reader has failed to read the medication-related information once, the second or subsequent reading operation could successfully be done. As a result, the subsequent processes that use the medication-related information can be continued.

### Second Mode

In the medication support apparatus according to the first aspect, the data retaining medium is a coded image such as the QR code 6c obtained by encoding the medication-related information.

Due to such a configuration, even if the reading of the coded image ends in failure once, the coded image is read again and the coded image could successfully be read. As a result, the subsequent processes that use the medication-related information, which is obtained from the coded image, can be continued.

### Third Aspect

In the medication support apparatus according to the second aspect, a change in the relative positions of the data retaining medium and the data reader includes a change in a direction approximately parallel to a display surface of the coded image.

Due to such a configuration, the coded image is to be read again after the reading operation for the coded image has failed, the relative positions of the code image and the data reader are changed from the relative positions at the time of failure. Accordingly, the second or subsequent reading operation is more likely to be done successfully.

### Fourth Aspect

In the medication support apparatus according to the second mode or the third aspect, a change in the relative positions of the data retaining medium and the data reader includes a change in a direction approximately orthogonal to a display surface of the coded image.

Due to such a configuration, the coded image is to be read again after the reading operation for the coded image has failed, the relative positions of the code image and the data reader are changed from the relative positions at the time of failure. Accordingly, the second or subsequent reading operation is more likely to be done successfully.

### Fifth Aspect

In the medication support apparatus according to any one of the second aspect to the fourth aspect, a change in the relative positions of the data retaining medium and the data reader includes a change in a tilt angle of the coded image with reference to a normal-line direction of a display surface of the coded image.

Due to such a configuration, the coded image is to be read again after the reading operation for the coded image has failed, the relative positions of the code image and the data reader are changed from the relative positions at the time of failure. Accordingly, the second or subsequent reading operation is more likely to be done successfully.

### Sixth Aspect

In the medication support apparatus according to any one of the second aspect to the fifth aspect, the data reader reads the medication-related information from the data retaining medium disposed on each of the medicine placement unit and one of the medicine pack and the container, and how the relative positions of the data retaining medium and the data reader change differs from one another between when the medication-related information is read from the data retaining medium of the one of the medicine pack and the container and when the medication-related information is read from the data retaining medium of the medicine placement unit.

Due to such a configuration, how the relative positions of the data retaining medium and the data reader change may be determined suitably depending on the situation including a case in which the medication-related information is read from the data retaining medium of the container or the medicine pack and a case in which the medication-related information is read from the data retaining medium of the medicine placement unit. Moreover, the probability of successful scanning when the medication-related information is read again can be increased for each case.

### Seventh Aspect

In the medication support apparatus according to any one of the first aspect to the sixth aspect, when the medicine pack is picked up from the container by the conveyor, the controller causes the data reader to read the medication-related information from the data retaining medium disposed on at least one of the medicine pack or the container.

Due to such a configuration, the conveyor can stably obtain the medication-related information of the medicine pack that is taken out from the container and is conveyed or the container from which the medicine pack is taken out by the conveyor.

### Eighth Mode

In the medication support apparatus according to any one of the first aspect to the seventh aspect, when the medicine pack conveyed by the conveyor is placed in the medicine placement unit, the controller causes the data reader to read the medication-related information from the data retaining medium disposed on at least one of the medicine pack or the medicine placement unit.

Due to such a configuration, the medication-related information of the medicine placement unit into which the medicine pack is to be placed by the conveyor can be obtained with high stability.

### Ninth Mode

In the medication support apparatus according to any one of the first aspect to the eighth aspect, after the medication-related information is read again, the controller returns the relative positions of the data retaining medium and the data reader to original relative positions before a change.

Due to such a configuration in which the relative positions of the data retaining medium and the data reader are returned to the original relative positions after the medication-related information is read again, the subsequent control operation can be done in a similar manner when the medication-related information has not successfully been read and the medication-related information is to be read again and when the medication-related information has successfully been read. Accordingly, the control becomes easy.

### Tenth Aspect

In the medication support apparatus according to any one of the first aspect to the ninth aspect, when the data reader fails to read the medication-related information again after the medication-related information is read again, the controller further changes the relative positions of the data retaining medium and the data reader, and causes the data reader to read the medication-related information again.

Due to such a configuration, an operation in which the relative positions of the data retaining medium and the data reader are changed and the medication-related information is read again from the data retaining medium can be performed several times. Accordingly, the probability of successful scanning can be increased.

### Eleventh Mode

In the medication support apparatus according to any one of the first aspect to the tenth aspect, the controller causes the data reader to read the medication-related information while the relative positions of the data retaining medium and the data reader are being changed.

Due to such a configuration, the probability of successful scanning of the medication-related information from the data retaining medium can be increased.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

What is claimed is:

1. A medication support apparatus comprising:
a container to store a medicine pack;
a conveyor to pick up the medicine pack from the container and convey the medicine pack to a medicine placement unit in which the medicine pack is to be placed;
a data reader to read medication-related information from a data retaining medium disposed on at least one of the medicine placement unit, the container, and the medicine pack; and
circuitry configured to control a reading operation by the data reader,
wherein when the data reader fails to read the medication-related information from the data retaining medium, the circuitry changes relative positions of the data retaining medium and the data reader, and causes the data reader to read the medication-related information again from the data retaining medium.

2. The medication support apparatus according to claim 1,
wherein the data retaining medium is a coded image obtained by encoding the medication-related information.

3. The medication support apparatus according to claim 2,
wherein a change in the relative positions of the data retaining medium and the data reader includes a change in a direction approximately parallel to a display surface of the coded image.

4. The medication support apparatus according to claim 2,
wherein a change in the relative positions of the data retaining medium and the data reader includes a change in a direction approximately orthogonal to a display surface of the coded image.

5. The medication support apparatus according to claim 2,
wherein a change in the relative positions of the data retaining medium and the data reader includes a change in a tilt angle of the coded image with reference to a normal-line direction of a display surface of the coded image.

6. The medication support apparatus according to claim 1,
wherein the data reader reads the medication-related information from the data retaining medium disposed on each of the medicine placement unit and one of the medicine pack and the container, and
wherein how the relative positions of the data retaining medium and the data reader change differs from one another between when the medication-related information is read from the data retaining medium of the one of the medicine pack and the container and when the medication-related information is read from the data retaining medium of the medicine placement unit.

7. The medication support apparatus according to claim 1,
wherein when the medicine pack is picked up from the container by the conveyor, the circuitry causes the data reader to read the medication-related information from the data retaining medium disposed on at least one of the medicine pack or the container.

8. The medication support apparatus according to claim 1,
wherein when the medicine pack conveyed by the conveyor is placed in the medicine placement unit, the circuitry causes the data reader to read the medication-related information from the data retaining medium disposed on at least one of the medicine pack or the medicine placement unit.

9. The medication support apparatus according to claim 1,
wherein after the medication-related information is read again, the circuitry returns the relative positions of the data retaining medium and the data reader to original relative positions before a change.

10. The medication support apparatus according to claim 1,
wherein when the data reader fails to read the medication-related information again after the medication-related information is read again, the circuitry further changes the relative positions of the data retaining medium and the data reader, and causes the data reader to read the medication-related information again.

11. The medication support apparatus according to claim 1,
wherein the circuitry causes the data reader to read the medication-related information while the relative positions of the data retaining medium and the data reader are being changed.
